(19) United States
(12) Patent Application Publication
(10) Pub. No.: US 2025/0292530 A1
(43) Pub. Date: Sep. 18, 2025

(54) ELECTRONIC DEVICE AND METHOD FOR OBTAINING TRAINING DATA

(71) Applicant: THINKWARE CORPORATION, Seongnam-si (KR)

(72) Inventors: Yosep Park, Seongnam-si (KR); Hyunsuk OH, Seongnam-si (KR); Haejun JUNG, Seongnam-si (KR); Yechan CHOI, Seongnam-si (KR); Dongwon SHIN, Seongnam-si (KR)

(21) Appl. No.: 19/082,210

(22) Filed: Mar. 18, 2025

(30) Foreign Application Priority Data
Mar. 18, 2024 (KR) 10-2024-0037475

(51) Int. Cl. G06V 10/25; G06V 10/774; G06V 20/70

(52) U.S. Cl. CPC G06V 10/25; G06V 10/774; G06V 20/70; G06V 2201/07

(57) ABSTRACT

An electronic device may obtain first images from a first camera. The electronic device may obtain, through the communication circuitry, second images from a second camera of which a shutter speed is slower than a shutter speed of the first camera. The electronic device may identify a first image and a second image obtained at corresponding times from the first images and the second images. The electronic device may set a first region of interest (ROI) of an object with a specified type in the first image. The electronic device may set a second ROI at the same position as the first ROI in the second image. The electronic device may generate the first image with the first ROI set and the second image with the second ROI set as training data.

### CROSS-REFERENCE TO RELATED APPLICATIONS

This application is based on and claims priority to Korean Patent Application No. 10-2024-0037475, filed on Mar. 18, 2024, in the Korean Intellectual Property Office, the disclosure of which is incorporated by reference herein its entirety.

### BACKGROUND

### Field

The disclosure relates to an electronic device and method for obtaining training data.

### Description of Related Art

An electronic devices mounted on a vehicle to obtain images of the external environment may have difficulty obtaining clear images due to noise or blur caused by the environment (such as low luminance and dynamic environments).

Enhanced images may be obtained through de-noise or de-blur using an artificial intelligence.

The above-described information may be provided as related art for the purpose of helping understanding of the disclosure. No claim or determination is made as to whether any of the foregoing is applicable as background art in relation to the disclosure.

### SUMMARY

According to an embodiment, an electronic device may comprise communication circuitry. The electronic device may comprise memory storing instructions. The electronic device may comprise a processor operably coupled to the communication circuitry, and the memory. The instructions may, when executed by the processor, cause the electronic device to obtain, through the communication circuitry, first images from a first camera. The instructions may, when executed by the processor, cause the electronic device to obtain, through the communication circuitry, second images from a second camera of which a shutter speed is slower than a shutter speed of the first camera. The instructions may, when executed by the processor, cause the electronic device to identify a first image and a second image obtained at corresponding times from the first images and the second images. The instructions may, when executed by the processor, cause the electronic device to set a first region of interest (ROI) of an object with a specified type in the first image. The instructions may, when executed by the processor, cause the electronic device to set a second ROI at the same position as the first ROI in the second image. The instructions may, when executed by the processor, cause the electronic device to generate the first image with the first ROI set and the second image with the second ROI set as training data.

According to an embodiment, a method performed by an electronic device may be performed by an electronic device including communication circuitry. The method may comprise obtaining first images from a first camera through the communication circuitry. The method may comprise obtaining, through the communication circuitry, second images from a second camera of which a shutter speed is slower than a shutter speed of the first camera. The method may comprise identifying a first image and a second image obtained at a corresponding time from the first images and the second images. The method may comprise setting a first region of interest (ROI) of an object with a specified type in the first image. The method may comprise setting a second ROI at the same position as the first ROI in the second image. The method may comprise generating the first image with the first ROI set and the second image with the second ROI set as training data.

A non-transitory, computer-readable storage medium may store one or more programs including instructions. The instructions may, when executed by a processor of an electronic device including communication circuitry, cause the electronic device to obtain, through the communication circuitry, first images from a first camera. The instructions may, when executed by the processor, cause the electronic device to obtain, through the communication circuitry, second images from a second camera of which a shutter speed is slower than a shutter speed of the first camera. The instructions may, when executed by the processor, cause the electronic device to identify a first image and a second image obtained at corresponding times from the first images and the second images. The instructions may, when executed by the processor, cause the electronic device to set a first region of interest (ROI) of an object with a specified type in the first image. The instructions may, when executed by the processor, cause the electronic device to set a second ROI at the same position as the first ROI in the second image. The instructions may, when executed by the processor, cause the electronic device to generate the first image with the first ROI set and the second image with the second ROI set as training data.

According to an embodiment, an electronic device and method may obtain training data to train artificial intelligence for de-noise and de-blur.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device;

FIGS. 2A, 2B, 2C and 2D illustrate an example of frames obtained through cameras;

FIG. 3 illustrates an example of a ground truth (GT) image and a blur image obtained through cameras;

FIG. 4 illustrates an example of an operation of cropping a GT image and a blur image;

FIG. 5 illustrates an example of an operation of extracting a region of interest from a GT image;

FIG. 6 illustrates an example of an operation of setting a region of interest in a blur image;

FIG. 7 is an exemplary flowchart illustrating operations of an electronic device according to an embodiment;

FIG. 8 is a block diagram illustrating an example of an autonomous driving system of a vehicle according to an embodiment;

FIGS. 9 and 10 are block diagrams illustrating an example of an autonomous driving moving object according to an embodiment;

FIG. 11 illustrates an example of a gateway related to a user device according to various

embodiments;

FIG. 12 is a view illustrating operations of an electronic device training a neural network based on a set of training data according to an embodiment;

FIG. 13 is a block diagram illustrating an electronic device according to an embodiment;

FIG. 14 is a view illustrating a state in which a tractor and a trailer are not connected; and

FIG. 15 is a view illustrating a state in which a tractor and a trailer are connected.

### DETAILED DESCRIPTION

Hereinafter, embodiments of the disclosure are described with reference to the accompanying drawings. With regard to the description of the drawings, similar reference numerals may be used to refer to similar or related elements.

Throughout the years, the trucking industry experienced steady growth and expanded the reach of its services to respond to more complex supply chains. These services include last-mile deliveries, drop-trailer programs, and intermodal transportation at ports (in which freight is carried to the destination by two or more different means of transportation (ship and rail, ship and airplane).

As such, because the methods of transporting freight are very diverse, manufacturers of freight-related equipment have designed different types of equipment to transport freight according to various transportation needs.

In the disclosure, a truck that tows a trailer for the main purpose of freight carrying or catering is collectively referred to as a tractor.

Tractors described in the disclosure may be classified into conventional trucks (or bonneted trucks), cab-over trucks (or cab-over engines), and semi-conventional trucks, which are intermediate forms of conventional trucks and cab-over trucks, depending on the location and shape of the tractor's cab.

The conventional truck has a structure in which the engine and the hood are positioned on the front axle of the tractor's cap, allowing the driver to sit behind the front axle, and is a type of tractor mainly used in North America where the tractor's engine is positioned in front of the driver.

On the other hand, the cap-over truck has a structure in which the cap of the tractor is positioned to the front end of the tractor, allowing the driver to sit in front of the front axle, and the front of the tractor is in the form of a so-called “flat face (or flat nose)” where the tractor's engine is positioned below the driver, which is a type of tractor mainly used in most countries such as Europe and Asia.

Just as there are various forms depending on the purpose and demand of a tractor, there are various forms of trailers towed by tractors. Among them, the most representative types of trailers are full-trailers and semi-trailers. The full-trailer and the semi-trailer may be distinguished by whether the trailer is equipped with both front and rear axles. Such a trailer may be connected to a box truck or a tractor through a coupling device.

Specifically, the full-trailer is a commercial freight trailer equipped with both front and rear axles. The full-trailer is designed to support the total load only with the trailer, so that it may fully support its weight without relying on a tractor, and is equipped with a drawbar to be coupled with a hauling unit (or towing unit) such as a tractor, and is mainly in the United States and Canada.

On the other hand, the semi-trailer is a freight trailer equipped with only a rear axle without a front axle, and supports a large portion of the load by a tractor connected by a type of hitch called a “fifth wheel.” When the semi-trailer is detected from the tractor and becomes stationary, the load of the trailer may be supported by spreading the landing gear mounted on the lower portion of the semi-trailer perpendicularly to the ground. A combination of a semi-trailer and a tractor is referred to as a “semi-trailer truck” (in the U.S., simply referred to as a “semi-trailer,”, a “tractor-trailer,” a “semi-truck,” a “big rig,” or a “semi”). The above-described “fifth wheel” refers to a horizontal wheel attached to the tractor axle of the trailer truck to facilitate the direction change of the trailer. The “fifth wheel” is a device that allows the tractor and the semi-trailer to be operably coupled to each other and typically includes a lower portion constituted of a hitch device and a trunnion plate for securing the kingpin mounted on the semi-trailer to the tractor.

Hereinafter, in the disclosure, based on the terms of the tractors/trailers described above, “trailer” is used as referring to a freight transportation vehicle connected to a tractor for a trailer, and “trailer” is used as referring to a towing vehicle for moving the trailer for convenience of description. Further, in the disclosure, in order to exclude the limitation of rights according to the embodiments described in the detailed description as much as possible, a tractor that hauls/tows a “trailer” may be described interchangeably with “towing vehicle” and a trailer towed by a tractor may be described interchangeably with “towed vehicle.”

Further, for convenience of description, it is preferable to understand that the “trailer” described throughout the specification refers to a “semi-trailer,” but is not limited thereto.

In an embodiment, the electronic device 101 and cameras 151 and 155 may be included (or mounted) to the vehicle. The electronic device 101 may correspond to, or be included in, an electronic controller (ECU) in the vehicle. The ECU may be referred to as an electronic control module (ECM). The electronic device 101 may be configured as a piece of independent hardware for the purpose of providing functions according to an embodiment of the disclosure in a vehicle. Embodiments are not limited thereto, and the electronic device 101 may correspond to, or be included in, a device (e.g., a black box) attached to the vehicle.

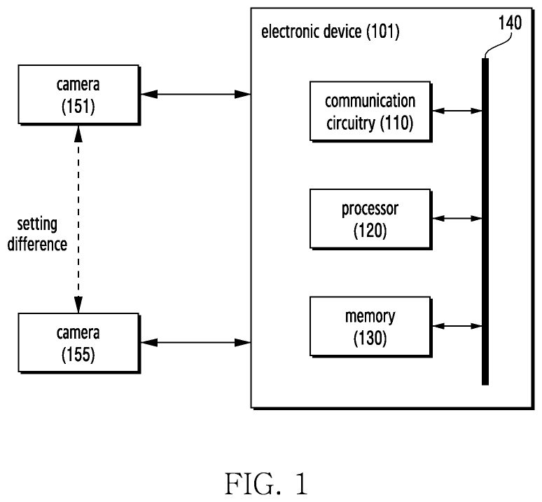

Referring to FIG. 1, according to an embodiment, the electronic device 101 may include communication circuitry 110, a processor 120, and memory 130. The communication circuitry 110, the processor 120, and the memory 130 may be electrically and/or operatively connected to each other by an electronic component such as a communication bus 140. Hereinafter, “pieces of hardware are operatively coupled” may mean that a direct or indirect connection between the pieces of hardware is established wiredly or wirelessly so that a second piece of hardware is controlled by a first piece of hardware among the pieces of hardware. Although different blocks are illustrated, embodiments are not limited thereto. Some of the pieces of hardware of FIG. 1 may be included in a single integrated circuit such as a system on chip (SoC). The type and/or number of the pieces of hardware included in the electronic device 101 is not limited as illustrated in FIG. 1. For example, the electronic device 101 may include only some of the pieces of hardware illustrated in FIG. 1.

According to an embodiment, the communication circuitry 110 of the electronic device 101 may include hardware components for transmitting and/or receiving electric signals between the electronic device 101 and external electronic device (e.g., the cameras 151 and 155). The communication circuitry 110 may include at least one of, e.g., a modem, an antenna, and an optic/electronic (O/E) converter. The communication circuitry 110 may support transmission and/or reception of electric signals based on various types of protocols such as Ethernet, local area network (LAN), wide area network (WAN), wireless fidelity (Wi-Fi), Bluetooth, Bluetooth low energy (BLE), ZigBee, long term evolution (LTE), 5G new radio (NR), and/or 6G.

According to an embodiment, the electronic device 101 may include hardware for processing data based on one or more instructions. The hardware for processing the data may include a processor 120. For example, the hardware for processing the data may include an arithmetic and logic unit (ALU), a floating point unit (FPU), a field programmable gate array (FPGA), a central processing unit (CPU), and/or an application processor (AP). The processor 120 may have a structure of a single-core processor or a structure of a multi-core processor such as a dual core, a quad core, a hexa core, or an octa core.

According to an embodiment, the memory 130 of the electronic device 101 may include a hardware component for storing data and/or instructions input and/or output to/from the processor 120 of the electronic device 101. The memory 130 may include, e.g., volatile memory such as random-access memory (RAM), and/or non-volatile memory such as read-only memory (ROM). For example, the volatile memory may include, e.g., at least one of dynamic RAM (DRAM), static RAM (SRAM), cache RAM, and pseudo SRAM (PSRAM). For example, the non-volatile memory may include at least one of, e.g., programmable ROM (PROM), erasable PROM (EPROM), electrically erasable PROM (EEPROM), flash memory, hard disk, compact disk, solid state drive (SSD), and embedded multi-media card (eMMC).

Although not shown, the electronic device 101 may further include various components. For example, the electronic device 101 may further include a display for displaying a user interface.

According to an embodiment, each of the cameras 151 and 155 may include a lens assembly or an image sensor. The lens assembly may collect light emitted or reflected from an object whose image is to be taken. The lens assembly may include one or more lenses. According to an embodiment, each of the cameras 151 and 155 may include a plurality of lens assemblies. For example, some of the plurality of lens assemblies of each of the cameras 151 and 155 may have the same lens attribute (e.g., field of view, focal length, auto-focusing, f number, or optical zoom), or at least one lens assembly may have one or more lens attributes different from those of another lens assembly. The lens assembly may include a wide-angle lens or a telephoto lens. According to an embodiment, the flash may include one or more light emitting diodes (e.g., a red-green-blue (RGB) LED, a white LED, an infrared LED, or an ultraviolet LED), or a xenon lamp. For example, the image sensor may obtain an image corresponding to an object by converting light emitted or reflected from the object and transmitted via the lens assembly into an electrical signal. According to an embodiment, the image sensor may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor may be implemented using, e.g., a charged coupled device (CCD) sensor or a complementary metal oxide semiconductor (CMOS) sensor.

In an embodiment, each of the cameras 151 and 155 may have setting differences. In an embodiment, each of the cameras 151, 155 may have a difference in at least one of the plurality of settings. For example, the plurality of settings may include an angle (e.g., a tilt angle, a roll angle, and/or a pan angle) of each of the cameras 151 and 155. For example, the plurality of settings may include angle of view, resolution, and/or lens properties (e.g., angle of view, focal length, autofocus, f number, international organization for standardization (ISO) sensitivity, or optical zoom). For example, a plurality of settings may include a shutter speed. For example, the respective angles of the cameras 151 and 155 may be set (or arranged) to be the same (or substantially the same) (or corresponding to) as each other (by a hardware structure (e.g., a leveler, a case, a fixing table). For example, the respective resolutions of the cameras 151 and 155 and/or lens properties (e.g., angle of view, focal length, autofocus, f number, ISO sensitivity, or optical zoom) may be set to be the same (or substantially the same) (or corresponding to) as each other. For example, the respective shutter speeds of the cameras 151 and 155 may be different from each other. For example, the shutter speed of the camera 151 may be faster than the shutter speed of the camera 155. In an embodiment, as the shutter speed of the camera 151 is faster than the shutter speed of the camera 155, the image obtained through the camera 151 may be clearer than the image obtained through the camera 155. In an embodiment, as the shutter speed of the camera 151 is faster than the shutter speed of the camera 155, at least one of the resolution, white noise, or blur (or motion blur) may occur more in the image obtained through the camera 155 than the image obtained through the camera 151. Accordingly, identification of strings may be more difficult in the image obtained through the camera 155 than the image obtained through the camera 151.

In an embodiment, the image obtained through the camera 151 may be referred to as a ground truth image. In an embodiment, the image obtained through the camera 155 may be referred to as a blur image (or a motion blur image).

According to an embodiment, the cameras 151 and 155 may be positioned (or arranged) toward one direction of the vehicle (not shown). For example, the cameras 151 and 155 may be positioned (or arranged) toward the front direction and/or driving direction of the vehicle.

In FIG. 1, the cameras 151 and 155 are exemplified as being physically distinguished from the electronic device 101, but this is merely an example. According to an embodiment, some of the cameras 151 and 155 may be integrally formed with the electronic device 101. Alternatively, all of the cameras 151 and 155 may be integrally formed with the electronic device 101. For example, when all of the cameras 151 and 155 are integrally formed with the electronic device 101, the communication circuitry 110 may be a circuit (e.g., mobile industry processor interface (MIPI)) for interfacing between the cameras 151 and 155 and the processor 120.

Hereinafter, an operation in which the electronic device 101 collects training data through the cameras 151 and 155 is described.

In an embodiment, the processor 120 of the electronic device 101 may instruct (or command) the cameras 151 and 155 to photograph. In an embodiment, the processor 120 of the electronic device 101 may instruct (or command) the cameras 151 and 155 to photograph at the same (or substantially the same) (or corresponding to) times as each other. In an embodiment, the processor 120 may instruct (or command) the cameras 151 and 155 to photograph based on the movement of the vehicle. However, the disclosure is not limited thereto. In an embodiment, the processor 120 may instruct (or command) the cameras 151 and 155 to photograph regardless of the movement of the vehicle. For example, when the times are the same (or substantially the same) (or corresponding to) as each other, it may mean that the photographing instruction (or command) may be generated and/or transmitted within a designated offset (or frame interval according to the frame speed).

In an embodiment, the processor 120 may obtain an image stream from each of the cameras 151 and 155. In an embodiment, the image stream may be a data stream for images obtained at a set frame speed (e.g., frames per second, FPS). In an embodiment, the set frame speed may be 30 FPS. However, the disclosure is not limited thereto. In an embodiment, the set frame speed may be smaller than 30 FPS (e.g., 24 FPS) or larger (e.g., 60 FPS).

In an embodiment, the processor 120 may store a designated number (e.g., 10) images obtained at the set frame speed after the photographing command in the memory 130 (or a buffer of the memory 130. In an embodiment, the processor 120 may store images obtained for a designated time (e.g., 0.3 seconds) after the photographing command in the memory 130 (or the buffer of the memory 130). For example, the processor 120 may store a designated number (e.g., 10) of ground truth (GT) images obtained from the camera 151 for a designated time and a designated number (e.g., 10) of blur images obtained from the camera 155 for a designated time in the memory 130 (or the buffer of the memory 130).

In an embodiment, the processor 120 may identify whether the vehicle is moving based on GT images and blur images obtained from the cameras 151 and 155. In an embodiment, the processor 120 may identify whether the vehicle is moving based on a comparison between consecutive images. For example, the processor 120 may identify whether the vehicle is moving based on a comparison between consecutive GT images (or blur images). Here, the comparison between consecutive images may be based on comparing the feature map of the image of the first frame with the feature map of the image of the second frame after the first frame. The comparison between consecutive images may be based on a differential image between the image of the first frame and the image of the second frame. Here, the second frame may be a frame obtained after the first frame according to the set frame speed. Here, the feature map may be obtained based on a neural network. However, the disclosure is not limited thereto.

In an embodiment, the processor 120 may identify that the vehicle is stopped based on a difference between consecutive images being smaller than or equal to a designated reference difference. In an embodiment, the processor 120 may identify that the vehicle is moving based on the difference between consecutive images exceeds a designated reference difference. For example, the processor 120 may identify that the vehicle is moving based on the size of the region exceeding the reference difference in the feature map of the image of the first frame and the feature map of the image of the second frame being a reference size or more. For example, the processor 120 may identify that the vehicle is stopped based on the size of the region exceeding the reference difference in the feature map of the image of the first frame and the feature map of the image of the second frame being smaller than the reference size. For example, the processor 120 may identify that the vehicle is moving based on the size of the region exceeding the reference difference in the differential image between the image of the first frame and the image of the second frame being the reference size or more. For example, the processor 120 may identify that the vehicle is stopped based on the size of the region exceeding the reference difference in the differential image between the image of the first frame and the image of the second frame being smaller than the reference size.

In an embodiment, the processor 120 may identify duplicate images based on GT images and blur images obtained from the cameras 151 and 155. In an embodiment, the processor 120 may identify a duplicate image based on a comparison between consecutive images. For example, the processor 120 may identify duplicate images based on comparison between consecutive GT images (or blur images). Here, the comparison between consecutive images may be based on comparing the feature map of the image of the first frame with the feature map of the image of the second frame after the first frame. The comparison between consecutive images may be based on a differential image between the image of the first frame and the image of the second frame. Here, the second frame may be a frame obtained after the first frame according to the set frame speed. Here, the feature map may be obtained based on a neural network. However, the disclosure is not limited thereto.

In an embodiment, the processor 120 may indicate that consecutive images are duplicate images based on a difference between consecutive images being a designated reference difference or less. In an embodiment, the processor 120 may delete (or remove) one of the duplicate images.

In an embodiment, the processor 120 may determine whether to process GT images and blur images obtained from the cameras 151 and 155. For example, the processor 120 may determine whether to process GT images and blur images based on whether the GT images and blur images are obtained while the vehicle is moving. For example, the processor 120 may determine to process GT images and blur images when GT images and blur images are obtained while the vehicle is moving. However, the disclosure is not limited thereto.

In an embodiment, the processor 120 may align times between a designated number of GT images and blur images. In an embodiment, when it is determined to process GT images and blur images, the processor 120 may align times between a designated number of GT images and blur images. For example, the processor 120 may align the times by comparing the reference image among the images obtained through the reference camera with the images obtained through another camera. For example, the reference camera is the camera 151, and the reference image may be an intermediate image (e.g., a fifth image) among the designated number of images. In this case, the processor 120 may compare the fifth GT image with 10 blur images to identify the blur image obtained at the same time (or substantially the same time) (or corresponding times) as the fifth GT image.

For example, the comparison between the GT image and the blur image may be based on the comparison between the feature map of the GT image and the feature map of the blur image. For example, the electronic device 101 may identify GT images and blur images obtained at the same time based on comparing the size of the region exceeding the reference difference in the feature map of the GT image and the feature map of the blur image and the reference size. For example, the processor 120 may identify the GT image and the blur image as images not obtained at the same time based on the size of the region exceeding the reference difference in the feature map of the GT image and the feature map of the blur image being the reference size or more. For example, the processor 120 may identify the GT image and the blur image as images obtained at the same time based on the size of the region exceeding the reference difference in the feature map of the GT image and the feature map of the blur image being smaller than the reference size. Here, the feature map may be obtained based on a neural network. However, the disclosure is not limited thereto.

For example, the comparison between the GT image and the blur image may be based on the differential image between the GT image and the blur image. For example, the electronic device 101 may identify GT images and blur images obtained at the same time based on comparing the size of the region exceeding the reference difference in the differential image with the reference size. For example, the processor 120 may identify the GT image and the blur image as images not obtained at the same time based on the size of the region exceeding the reference difference in the differential image between the GT image and the blur image being the reference size or more. For example, the processor 120 may identify the GT image and the blur image as images obtained at the same time based on the size of the region exceeding the reference difference in the differential image between the GT image and the blur image being smaller than the reference size.

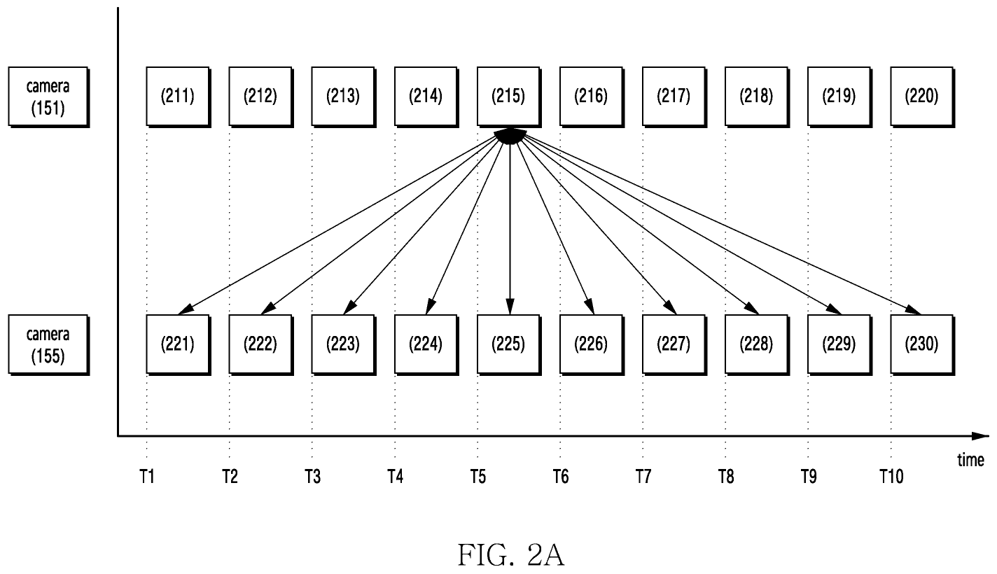

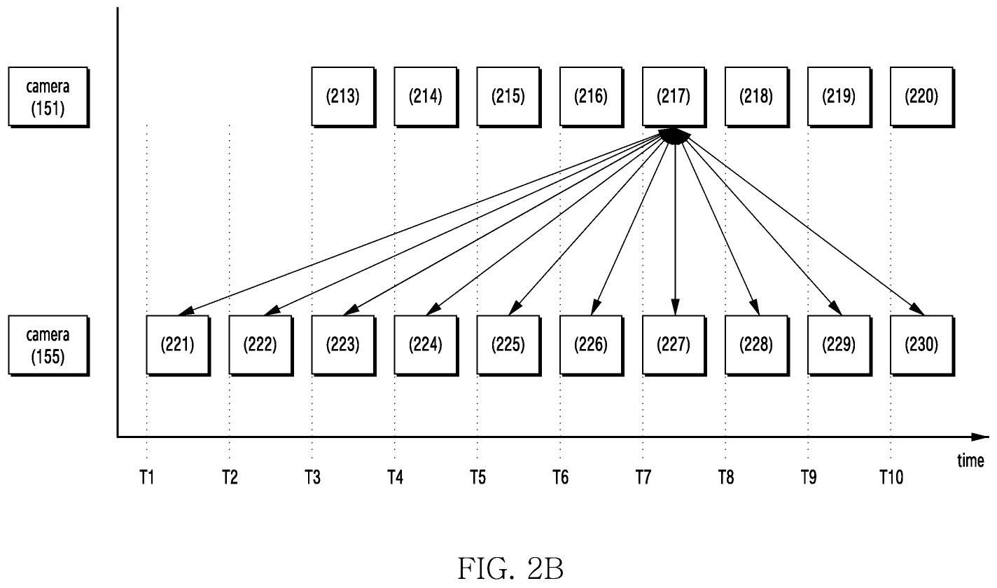

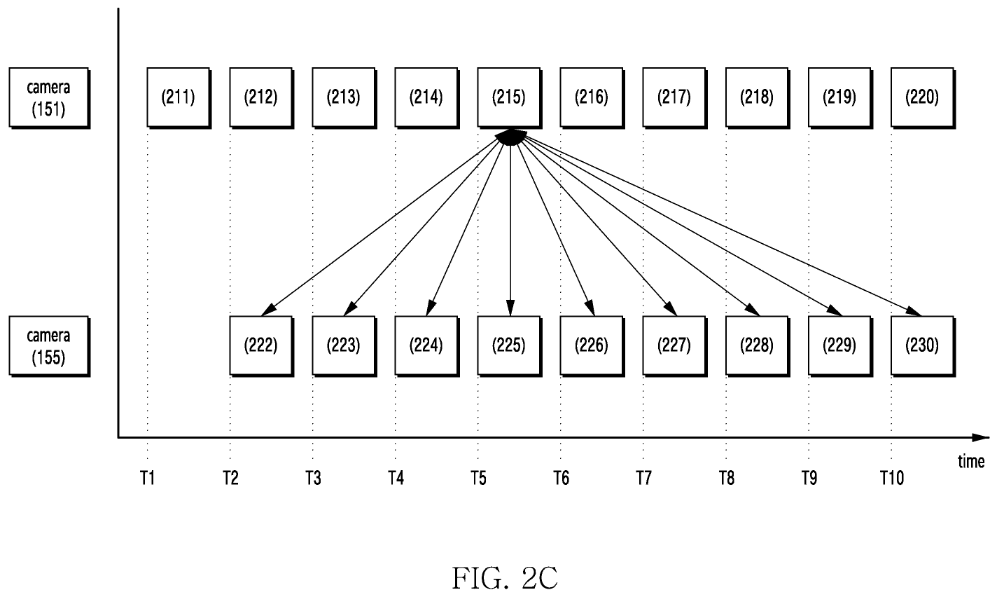

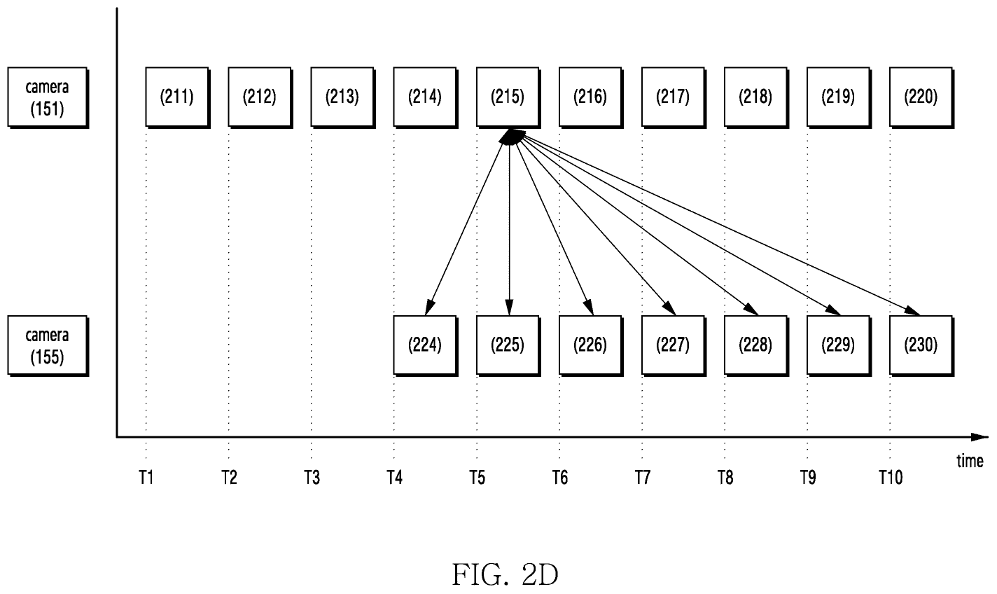

In an embodiment, obtaining the GT image and the blur image at substantially the same time (or corresponding times) may include that the difference in acquisition time between the GT image and the blur image is smaller than or equal to a frame interval (or half of the frame interval) according to the set frame speed. The comparison between the GT image and the blur image may be described with reference to FIGS. 2A to 2D.

FIGS. 2A to 2D illustrate an example of frames obtained through cameras.

Referring to FIG. 2A, the cameras 151 and 155 may start photographing at the same time (or substantially the same time) (or corresponding times) (e.g., T1). In an embodiment, when the cameras 151 and 155 start photographing at substantially the same time (or corresponding times), the difference in photographing start time between the cameras 151 and 155 may be smaller than or equal to the frame interval (or half of the frame interval) according to the set frame speed. Accordingly, in FIG. 2A, 10 GT images 211 to 220 and 10 blur images 221 to 230 may be obtained at the same time (or substantially the same time) (or corresponding times). For example, the GT image 211 and the blur image 221 may be obtained at a time T1. For example, the GT images 212 to 220 and blur images 222 to 230 may be obtained at the times (e.g., T2 to T10), respectively.

In an embodiment, the processor 120 may align times between 10 GT images 211 to 220 and 10 blur images 221 to 230. For example, the processor 120 may compare each of the 10 blur images 221 to 230 obtained through the camera 155 (or another camera) with a GT image 215 of a designated number (or fifth) (e.g., reference image) among the GT images 211 to 220 obtained through the camera 151 (or reference camera). Here, the comparison between the GT image 215 and each of the 10 blur images 221 to 230 may be based on comparing the feature map of the GT image 215 with the feature map of each of the 10 blur images 221 to 230. The comparison between consecutive images may be based on a differential image between GT image 215 and each of 10 blur images 221 to 230. Here, the feature map may be obtained based on a neural network. However, the disclosure is not limited thereto.

In an embodiment, the processor 120 may determine a blur image in which a difference between the GT image 215 and each of the 10 blur images 221 to 230 is a designated reference difference or less as an image obtained at the same time as the GT image 215. For example, the processor 120 may determine the GT image 215 and blur image 225 as images obtained at the same time. Accordingly, the electronic device 101 may determine image sets obtained at the same time according to the acquisition order (or frame order) of 10 GT images 211 to 220 and 10 blur images 221 to 230. For example, the electronic device 101 may identify a blur image having the same frame difference as the frame difference between a specific GT image, among the 10 GT images 211 to 220, and the reference image from the 10 blur images 221 to 230. In an embodiment, the electronic device 101 may determine the specific image and the identified blur image as image sets obtained at the same time. For example, as the GT image 215 and the blur image 225 are determined as images obtained at the same time, the GT image 211 and the blur image 221 may be determined as images obtained at the same time (e.g., T1).

Referring to FIG. 2B, the camera 151 may start photographing at a time (e.g., T3) later than the camera 155 by a time corresponding to a time of two frames. Accordingly, eight GT images 213 to 220 and 10 blur images 221 to 230 may be obtained in FIG. 2B after the photographing command of the processor 120. For example, blur images 221 and 222 may be obtained at times T1 and T2. For example, the GT images 213 to 220 and blur images 223 to 230 may be obtained at the times (e.g., T3 to T10), respectively.

In an embodiment, the processor 120 may align times between eight GT images 213 to 220 and 10 blur images 221 to 230. For example, the processor 120 may compare the GT image 217 of a designated number (e.g., fifth) among the GT images 213 to 220 obtained through the camera 151 and each of the 10 blur images 221 to 230 obtained through the camera 155.

In an embodiment, the processor 120 may determine a blur image in which a difference between the GT image 217 and each of the 10 blur images 221 to 230 is a designated reference difference or less as an image obtained at the same time as the GT image 217. For example, the processor 120 may determine the GT image 217 and blur image 227 as images obtained at the same time. Accordingly, the electronic device 101 may determine image sets obtained at the same time according to the acquisition order (or frame order) of eight GT images 213 to 220 and 10 blur images 221 to 230. For example, as the GT image 217 and the blur image 227 are determined as images obtained at the same time, the GT image 213 and the blur image 223 may be determined as images obtained at the same time.

Referring to FIG. 2C, the camera 155 may start photographing at a time (e.g., T2) later than the camera 151 by a time corresponding to a time of one frame. Accordingly, 10 GT images 211 to 220 and 9 blur images 222 to 230 may be obtained in FIG. 2C after the photographing command of the processor 120. For example, the GT image 211 may be obtained at a time T1. For example, the GT images 212 to 220 and blur images 222 to 230 may be obtained at the times (e.g., T2 to T10), respectively.

In an embodiment, the processor 120 may align times between 10 GT images 211 to 220 and 9 blur images 222 to 230. For example, the processor 120 may compare the GT image 215 of a designated number (e.g., fifth) among the GT images 211 to 220 obtained through the camera 151 and each of the 9 blur images 222 to 230 obtained through the camera 155.

In an embodiment, the processor 120 may determine a blur image in which a difference between the GT image 215 and each of the 9 blur images 222 to 230 is a designated reference difference or less as an image obtained at the same time as the GT image 215. For example, the processor 120 may determine the GT image 215 and blur image 225 as images obtained at the same time. Accordingly, the electronic device 101 may determine image sets obtained at the same time according to the acquisition order (or frame order) of 10 GT images 211 to 220 and 9 blur images 222 to 230. For example, as the GT image 215 and the blur image 225 are determined as images obtained at the same time, the GT image 212 and the blur image 222 may be determined as images obtained at the same time.

Referring to FIG. 2D, the camera 155 may start photographing at a time (e.g., T4) later than the camera 151 by a time corresponding to a time of three frames. Accordingly, 10 GT images 211 to 220 and 7 blur images 224 to 230 may be obtained in FIG. 2D after the photographing command of the processor 120. For example, the GT images 211, 212, and 213 may be obtained at times T1, T2, and T3. For example, the GT images 214 to 220 and blur images 224 to 230 may be obtained at the times, respectively (e.g., T4 to T10).

In an embodiment, the processor 120 may align times between 10 GT images 211 to 220 and 7 blur images 224 to 230. For example, the processor 120 may compare the GT image 215 of a designated number (e.g., fifth) among the GT images 211 to 220 obtained through the camera 151 and each of the 7 blur images 224 to 230 obtained through the camera 155.

In an embodiment, the processor 120 may determine a blur image in which a difference between the GT image 215 and each of the 7 blur images 224 to 230 is a designated reference difference or less as an image obtained at the same time as the GT image 215. For example, the processor 120 may determine the GT image 215 and blur image 225 as images obtained at the same time. Accordingly, the electronic device 101 may determine image sets obtained at the same time according to the acquisition order (or frame order) of 10 GT images 211 to 220 and 7 blur images 224 to 230. For example, as the GT image 215 and the blur image 225 are determined as images obtained at the same time, the GT image 214 and the blur image 224 may be determined as images obtained at the same time.

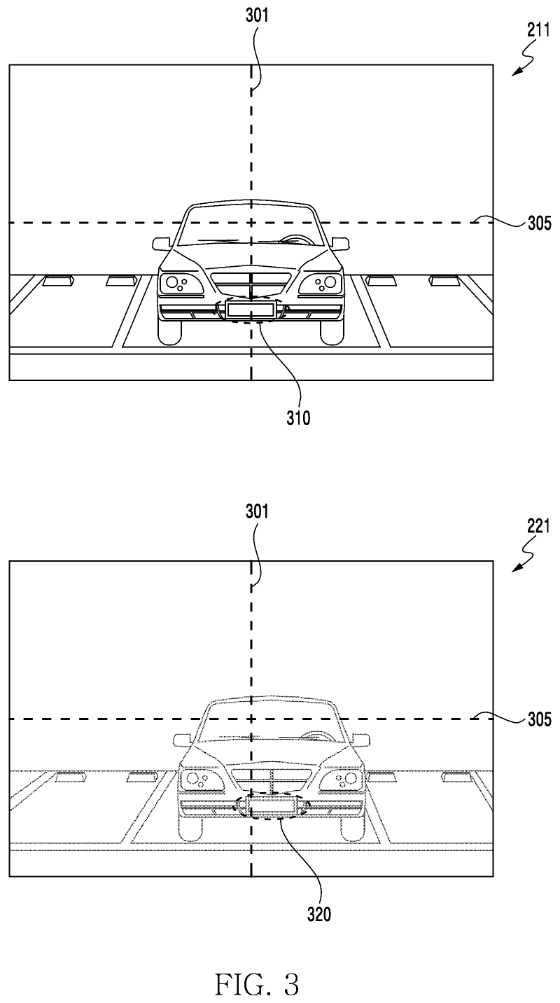

In an embodiment, the processor 120 may generate a training data set based on the GT image and the blur image obtained at the same time (or substantially the same time) (or corresponding times). The training data set may include images based on a pair of GT image and blur image. The training data may include a plurality of training data sets. Generation of the training data set may be described with reference to FIGS. 3 to 6.

FIG. 3 illustrates an example of a ground truth (GT) image and a blur image obtained through cameras.

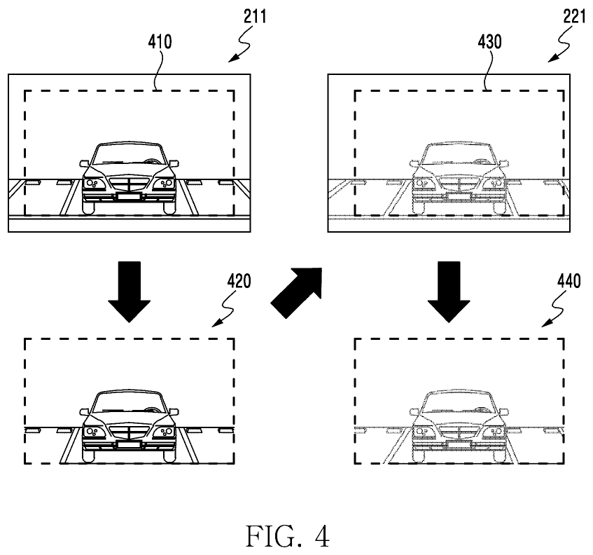

Referring to FIG. 3, the GT image 211 and the blur image 221 may have different fields of view (FOV) due to a difference in physical position between the cameras 151 and 155. For example, the license plate 310 of the vehicle of the GT image 211 may be positioned across the left and right sides of the center vertical line 301 of the GT image 211, while the license plate 320 of the vehicle of the blur image 221 may be positioned on the right side of the center vertical line 301 of the blur image 221. In FIG. 3, it is illustrated that the vehicle region of the GT image 211 and the blur image 221 is mostly positioned below the horizontal center line 305, but the FOVs of the cameras 151 and 155 may vary depending on the arrangement position and/or angle of each of the cameras 151 and 155. Accordingly, in order to generate training data based on the GT image 211 and the blur image 221, predetermined image processing for the GT image 211 and the blur image 221 may be required. Hereinafter, an image processing operation for the GT image 211 and the blur image 221 for generating training data is described with reference to FIGS. 4 to 6.

FIG. 4 illustrates an example of an operation of cropping a GT image 211 and a blur image 221.

In an embodiment, the processor 120 may crop the GT image 211. For example, the processor 120 may remove the outer region of the GT image 211 by cropping the GT image 211. In an embodiment, the processor 120 may obtain (or extract) (or generate) a cropped GT image 420 by cropping the region 410 of a designated size (e.g., 90% of the GT image 211) of the GT image 211. In an embodiment, the processor 120 may obtain the cropped GT image 420 by cropping a designated region 410 (e.g., a central region) of the GT image 211. However, the disclosure is not limited thereto. In an embodiment, the processor 120 may obtain a cropped GT image 420 by cropping a region including an object. In an embodiment, the processor 120 may identify the object in the GT image 211 through an object detection (OD) model. In an embodiment, the processor 120 may obtain the cropped GT image 420 by cropping the region 410 including the identified object.

In an embodiment, the processor 120 may identify another region 430 corresponding to the cropped GT image 420 from the blur image 221 obtained at the same time as the GT image 211. In an embodiment, the processor 120 may compare the blur image 221 with the cropped GT image 420 to identify the other region 430.

For example, the comparison between the cropped GT image 420 and the blur image 221 may be based on a differential image between the cropped GT image 420 and each of specific regions of the blur image 221. In an embodiment, the specific regions may be regions compared with the cropped GT image 420. In an embodiment, the specific regions may be regions positioned as the cropped GT image 420 is shifted from the blur image 221. For example, the electronic device 101 may identify a specific region related to the differential image with the least difference (or the highest matching rate) among the differential images as the other region 430 of the blur image 221. However, the disclosure is not limited thereto. In an embodiment, the electronic device 101 may identify the other region 430 of the blur image 221 based on comparing the feature maps of the cropped GT image 420 and the blur image 221.

For example, the comparison between the cropped GT image 420 and the blur image 221 may be based on a difference in distance between feature point coordinates between the cropped GT image 420 and each of the specific regions of the blur image 221. For example, the electronic device 101 may identify the feature points of the cropped GT image 420. For example, the feature points may include specific positions (e.g., the headlight, license plate, or head) of objects (e.g., a vehicles, a building, or a pedestrian) included in the cropped GT image 420. For example, the electronic device 101 may identify feature points of the blur image 221. For example, the electronic device 101 may identify the distance between the feature point of the cropped GT image 420 and the feature point in each specific region of the blur image 221 corresponding to each other. In an embodiment, the electronic device 101 may identify a specific region having the shortest distance between the feature points as the other region 430 of the blur image 221.

For example, the comparison between cropped GT image 420 and blur image 221 may be based on the respective normalized difference values (e.g., normalization between 0 and 1) of the differential images and the normalized distance of distances in the specific regions, respectively. For example, the electronic device 101 may identify the specific region with the lowest weighted sum of the normalized difference value and the normalized distance as the other region 430 of the blur image 221.

In an embodiment, the processor 120 may crop (or obtain) (or extract) the other region 430 corresponding to the GT image 420 cropped from the blur image 221 as the cropped blur image 440. In an embodiment, the size of the cropped blur image 440 may be the same as the size of the cropped GT image 420. In an embodiment, the type, size, and position of the object included in the cropped GT image 420 may be the same as the type, size, and position of the object included in the cropped blur image 440.

According to an embodiment, the processor 120 may perform image correction on the cropped GT image 420. For example, the processor 120 may increase the brightness of the cropped GT image 420.

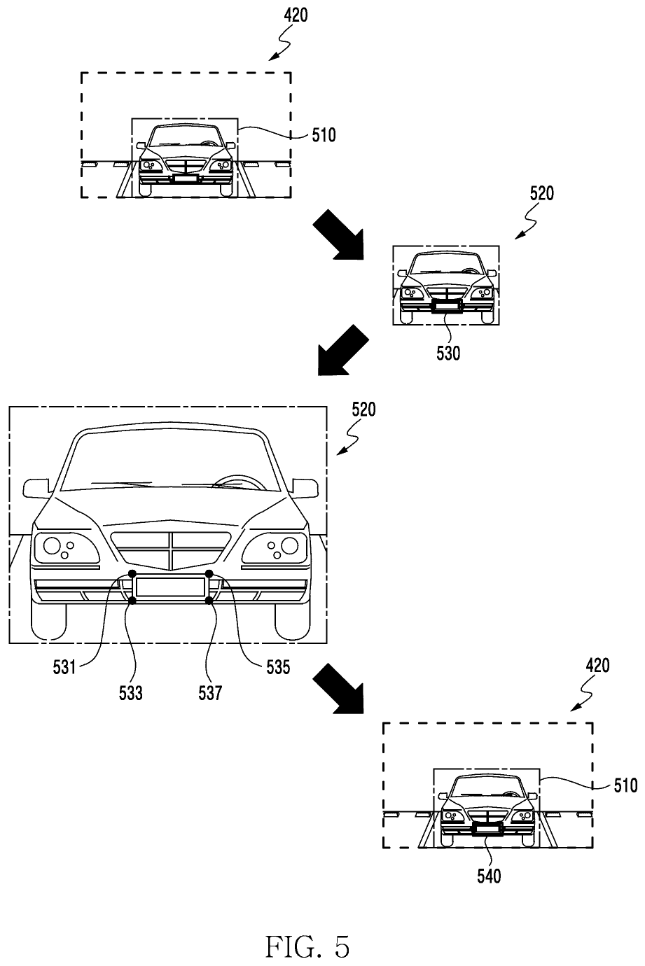

FIG. 5 illustrates an example of an operation of extracting a region of interest from a GT image 211.

Referring to FIG. 5, the processor 120 may identify an object from the cropped GT image 420. In an embodiment, the processor 120 may identify a designated type of object (e.g., vehicle, traffic sign, road marking) through an image segmentation model and/or object detection (OD) model in the cropped GT image 420. In an embodiment, the processor 120 may identify the object from the cropped GT image 420 by adjusting the size of the mask for identifying the object. In an embodiment, the processor 120 may use masks in a large order to identify the object.

In an embodiment, the processor 120 may extract (or obtain) the region 510 for the object (i.e., vehicle) identified in the cropped GT image 420 as the GT object image 520. In an embodiment, the processor 120 may obtain the GT object image 520 by cropping the region 510 including the identified object.

In an embodiment, the processor 120 may identify a region of interest 530 corresponding to the text region (e.g., the license plate of the vehicle, indication in the traffic sign, indication in the road marking) of the object in the GT object image 520. In an embodiment, the processor 120 may identify the region of interest 530 in the GT object image 520 based on the image segmentation model. In FIG. 5, the GT object image 520 at the lower left is merely an enlarged display of the GT object image 520 at the upper right, and the GT object image 520 at the lower left and the GT object image 520 at the upper right may be the same image.

In an embodiment, the processor 120 may calculate (or identify) (or determine) the vertices 531, 533, 535, and 537, through figure fitting (e.g., fitting through a triangle, rectangle, pentagon, or polygon) in the region of interest 530. In an embodiment, the processor 120 may identify the coordinates of each of the vertices 531, 533, 535, and 537 through figure fitting in the region of interest 530. For example, the electronic device 101 may identify the coordinates of each of the vertices 531, 533, 535, and 537 in a two-dimensional virtual coordinate system in which the lower left vertex 531 of the vertices 531, 533, 535, and 537 is set as the origin. For example, the x-axis of the two-dimensional virtual coordinate system may be formed along the lower edge of the GT object image 520. The y-axis of the two-dimensional virtual coordinate system may be formed along the left edge of the GT object image 520.

In an embodiment, the processor 120 may mark (or set) (or identify) (or designate) the region 510 of the object and the fitted region of interest 540 in the cropped GT image 420.

In an embodiment, the processor 120 may convert the fitted region of interest 540. For example, the processor 120 may convert the fitted region of interest 540 through a designated transformation algorithm (e.g., algorithm for rigid-body transformation, similarity transformation, linear transformation, affine transformation, and/or perspective transformation). In an embodiment, the processor 120 may convert the fitted region of interest 540 into a license plate-shaped figure (e.g., a rectangle). However, the disclosure is not limited thereto.

In an embodiment, an algorithm (or operation) for identifying (or recognizing) the character string displayed on the license plate may be performed on the (converted) fitted region of interest 540 of the cropped GT image 420. The algorithm may include an algorithm for identifying a character string of an image (e.g., an algorithm according to an optical character recognition (OCR) function)). In an embodiment, based on the OCR algorithm for the fitted region of interest 540 of the cropped GT image 420, the character string displayed on the license plate may be identified (or recognized).

In an embodiment, the processor 120 may label the character string displayed on the license plate in the fitted region of interest 540 of the cropped GT image 420.

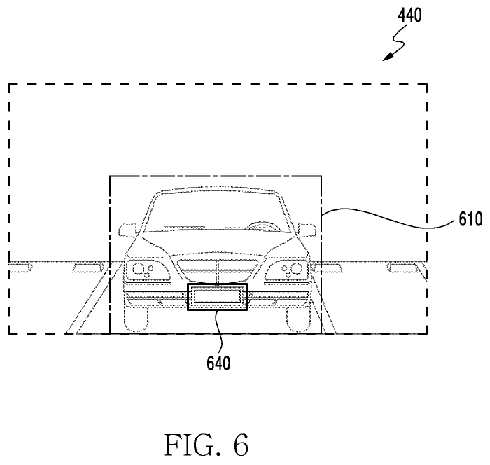

FIG. 6 illustrates an example of an operation of setting a region of interest in a blur image 221.

Referring to FIG. 6, the processor 120 may mark (or set) (or identify) (or designate) the region 610 of the object and the region of interest 640 in the cropped blur image 440. In an embodiment, the processor 120 may mark (or set) (or identify) (or designate) the region 610 of the object and the region of interest 640 in the cropped blur image 440 based on the region of object 510 and region of interest 540 of the cropped GT image 420. In an embodiment, the size and position of the region 610 of the object displayed on the cropped blur image 440 may be the same as the size and position of the region 510 of the object displayed on the cropped GT image 420. In an embodiment, the size and position of the region of interest 640 displayed on the cropped blur image 440 may be the same as the size and position of the region of interest 540 displayed on the cropped GT image 420.

In an embodiment, the processor 120 may label the character string displayed on the license plate on the region of interest 640 of the cropped blur image 440. In an embodiment, the character string may be the same as the character string identified in the fitted region of interest 540 of the cropped GT image 420.

In an embodiment, the processor 120 may set (or identify) (or obtain) the cropped GT image 420 where the region 510 of the object and the region of interest 540 are marked (or set) (or identified) or designated) and the cropped blur image 440 where the region 610 of the object and the region of interest 640 are marked (or set) (or identified) (or designated) as a training data set.

In an embodiment, the processor 120 may repeat the operations performed on the GT image 212 and the blur image 222, on the next images (e.g., the GT image 211 and blur image 221).

As described above, the electronic device 101 may construct training data based on GT images and blur images obtained at the same time (or substantially the same time) (or corresponding times). The electronic device 101 may construct training data based on the GT image and the blur image obtained according to different shutter speeds. Accordingly, the electronic device 101 may construct training data based on the GT image and the blur image with minimized user intervention. Further, the electronic device 101 may construct a large amount of training data by minimizing user intervention. Further, the electronic device 101 may construct an artificial intelligence model for de-blur and/or de-noise by learning the output results of the artificial intelligence model for the blur images based on the GT image. Accordingly, the electronic device 101 may restore a character string in the image that is not identified due to at least one of the resolution, white noise, or blur. Further, the electronic device 101 may construct a large amount of training data for traffic signs and/or road markings as well as license plates of vehicles.

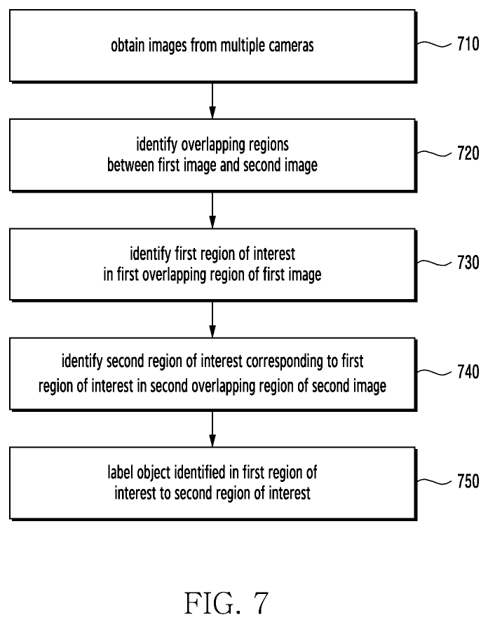

FIG. 7 is an exemplary flowchart illustrating operations of an electronic device according to an embodiment.

FIG. 7 may be described referring to FIGS. 1 to 6. Operations of FIG. 7 may be performed by the electronic device 101. The operations of FIG. 7 may be performed by executing instructions stored in the memory 130. The operations of FIG. 7 may be performed by the processor 120 executing instructions stored in the memory 130.

Referring to FIG. 7, in operation 710, the electronic device 101 may obtain images from a plurality of cameras 151 and 155. In an embodiment, the cameras 151 and 155 may have different shutter speeds. For example, the shutter speed of the camera 151 may be faster than the shutter speed of the camera 155. For example, the respective angles of the cameras 151 and 155 may be set (or arranged) to be the same (or substantially the same) (or corresponding to) as each other. For example, the respective resolutions of the cameras 151 and 155 and/or lens properties (e.g., angle of view, focal length, autofocus, f number, ISO sensitivity, or optical zoom) may be set to be the same (or substantially the same) (or corresponding to) as each other.

In an embodiment, the electronic device 101 may obtain images by instructing (or commanding) the cameras 151 and 155 to photograph at the same (or substantially the same) (or corresponding to) times as each other. For example, when the times are the same (or substantially the same) (or corresponding to) as each other, it may mean that the photographing instruction (or command) may be generated and/or transmitted within a designated offset (or frame interval according to the frame speed).

In operation 720, the electronic device 101 may identify an overlapping region between the first image and the second image. In an embodiment, the electronic device 101 may identify an overlapping region between a first image among the images obtained from the camera 151 and a second image obtained at the same time as the first image among the images obtained from the camera 155.

In an embodiment, the electronic device 101 may identify the overlapping region between the first image and the second image based on cropping the first image. For example, the electronic device 101 may remove an outer region of the first image by cropping the first image. In an embodiment, the electronic device 101 may obtain (or extract) (or generate) a cropped first image by cropping a region of a designated size (e.g., 90% of the first image) of the first image. In an embodiment, the electronic device 101 may obtain a cropped first image by cropping a designated region (e.g., a central region) of the first image.

In an embodiment, the electronic device 101 may identify another region corresponding to the cropped first image in the second image obtained at the same time as the first image. In an embodiment, the electronic device 101 may identify the other region by comparing the second image with the cropped first image.

For example, the comparison between the cropped first image and the second image may be based on a difference image between the cropped first image and each of specific regions of the second image. In an embodiment, the specific regions may be regions compared with the cropped first image. In an embodiment, the specific regions may be regions positioned as the cropped first image is shifted from the second image. For example, the electronic device 101 may identify a specific region related to the differential image with the least difference (or the highest matching rate) among the differential images as the other region of the second image. However, the disclosure is not limited thereto. In an embodiment, the electronic device 101 may identify the other region of the second image based on comparison between the feature maps of the cropped first image and the second image.

For example, the comparison between the cropped first image and the second image may be based on a difference in distance between feature point coordinates between the cropped first image and each of the specific regions of the second image. For example, the electronic device 101 may identify the feature points of the cropped first image. For example, the feature points may include specific positions (e.g., the headlight, license plate, or head) of objects (e.g., a vehicles, a building, or a pedestrian) included in the cropped first image. For example, the electronic device 101 may identify feature points of the second image. For example, the electronic device 101 may identify the distance between the feature point of the cropped first image and the feature point in each specific region of the second image corresponding to each other. In an embodiment, the electronic device 101 may identify a specific region having the shortest distance between the feature points as the other region of the second image.

For example, the comparison between the cropped first image and the second image may be based on the respective normalized difference values (e.g., normalization between 0 and 1) of the differential images and the normalized distance of distances in the specific regions, respectively. For example, the electronic device 101 may identify the specific region with the lowest weighted sum of the normalized difference value and the normalized distance as the other region of the second image.

In an embodiment, the electronic device 101 may crop (or obtain) (or extract) the other region corresponding to the cropped first image in the second image, as the second image. In an embodiment, the size of the cropped second image and the size of the cropped first image may be the same. In an embodiment, the type, size, and position of the object included in the cropped first image may be the same as the type, size, and position of the object included in the cropped second image.

In an embodiment, the electronic device 101 may identify the cropped first image and the cropped second image as overlapping regions between the first image and the second image.

In operation 730, the electronic device 101 may identify a first region of interest in a first overlapping region of the first image. In an embodiment, the electronic device 101 may sequentially perform object identification in the first overlapping region of the first image and identification of the first region of interest in the identified object.

In an embodiment, the electronic device 101 may identify an object in the cropped first image. In an embodiment, the electronic device 101 may identify a designated type of object (e.g., a vehicle, a traffic sign, or a road mark) through an image segmentation model and/or an object detection (OD) model in the cropped first image. In an embodiment, the electronic device 101 may identify the object from the cropped first image by adjusting the size of the mask for identifying the object. In an embodiment, the electronic device 101 may use masks in a large order to identify the object.

In an embodiment, the electronic device 101 may extract (or obtain) a region for an object (i.e., the vehicle) identified in the cropped first image as an object image. In an embodiment, the electronic device 101 may obtain the object image by cropping the region including the identified object.

In an embodiment, the electronic device 101 may identify a region of interest corresponding to the text region (e.g., the license plate of the vehicle, indication in the traffic sign, indication in the road marking) of the object in the object image. In an embodiment, the electronic device 101 may identify the region of interest in the object image based on an image segmentation model. In FIG. 5, the object image at the lower left is merely an enlarged image of the object image at the upper right, and the object image at the lower left and the object image at the upper right may be the same image.

In an embodiment, the electronic device 101 may calculate (or identify) (or determine) the vertices through figure fitting (e.g., fitting through a triangle, rectangle, pentagon, or polygon) in the region of interest. In an embodiment, the electronic device 101 may identify coordinates of each of the vertices through figure fitting in the region of interest. For example, the electronic device 101 may identify the coordinates of each of the vertices in a two-dimensional virtual coordinate system in which the lower left vertex of the vertices is set as the origin.

In an embodiment, the electronic device 101 may identify the fitted region of interest in the region of the object of the cropped first image.

In operation 740, the electronic device 101 may identify the second region of interest corresponding to the first region of interest in the second overlapping region of the second image. In an embodiment, the electronic device 101 may sequentially perform setting of an object region in the second overlapping region of the second image and setting of the second region of interest in the object region.

In an embodiment, the electronic device 101 may mark (or set) (or identify) (or designate) the region of the object and the region of interest in the cropped second image. In an embodiment, the electronic device 101 may mark (or set) (or identify) (or designate) the region of the object and the region of interest in the cropped second image based on the region of the object and the region of interest of the cropped first image. In an embodiment, the size and position of the region of the object displayed in the cropped second image may be the same as the size and position of the region of the object displayed in the cropped first image. In an embodiment, the size and position of the region of interest displayed on the cropped second image may be the same as the size and position of the region of interest displayed on the cropped first image.

In operation 750, the electronic device 101 may label the object identified in the first region of interest to the second region of interest. In an embodiment, the electronic device 101 may label the character string of the object identified in the first region of interest to the second region of interest.

In an embodiment, the electronic device 101 may convert the fitted region of interest. For example, the electronic device 101 may convert the fitted region of interest through a designated transformation algorithm (e.g., algorithm for rigid-body transformation, similarity transformation, linear transformation, affine transformation, and/or perspective transformation). In an embodiment, the electronic device 101 may convert the fitted region of interest into a license plate-shaped figure (e.g., a rectangle). However, the disclosure is not limited thereto.

In an embodiment, an algorithm (or operation) for identifying (or recognizing) the character string displayed on the license plate may be performed on the (converted) fitted region of interest of the cropped first image. The algorithm may include an algorithm for identifying a character string of an image (e.g., an algorithm according to an optical character recognition (OCR) function)). In an embodiment, based on the OCR algorithm for the fitted region of interest of the cropped first image, the character string displayed on the license plate may be identified (or recognized).

In an embodiment, the electronic device 101 may label the character string displayed on the license plate to the region of interest of the cropped second image. In an embodiment, the character string may be the same as the character string identified in the fitted region of interest of the cropped first image.

Thereafter, the electronic device 101 may set (or identify) (or obtain) a cropped first image where the region of the object and the region of interest are marked and a cropped second image where the region of the object and the region of interest are marked as a training data set.

Thereafter, the electronic device 101 may repeat the operations performed on the first image and the second image, on the next images (e.g., the first image and the second image).

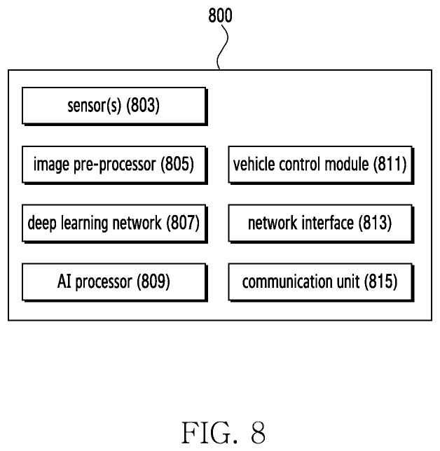

FIG. 8 is a block diagram illustrating an example of an autonomous driving system of a vehicle according to an embodiment.

An autonomous driving system 800 of a vehicle according to FIG. 8 may be a deep learning network including sensors 803, an image pre-processor 805, a deep learning network 807, an artificial intelligence (AI) processor 809, a vehicle control module 811, a network interface 813, and a communication unit 815. In various embodiments, the elements may be connected through various interfaces. For example, sensor data sensed and output by the sensors 803 may be fed to the image pre-processor 805. The sensor data processed by the image pre-processor 805 may be fed to the deep learning network 807 running on the AI processor 809. The output of the deep learning network 807 run by the AI processor 809 may be fed to the vehicle control module 811. Intermediate results of the deep learning network 807 running on the AI processor 809 may be fed to the AI processor 809. In various embodiments, the network interface 813 communicates with an electronic device (e.g., the electronic device 101 and/or the cameras 151 and 155 of FIG. 1) in the vehicle to transfer autonomous driving route information and/or autonomous driving control commands for autonomous driving of the vehicle to internal block components. In an embodiment, the network interface 813 may be used to transmit sensor data obtained through the sensor(s) 803 to an external server. In some embodiments, the autonomous driving system 800 may include additional or fewer components as appropriate. For example, in some embodiments, the image pre-processor 805 may be an optional component. As another example, a post-processing component (not shown) may be included in the autonomous driving system 800 to perform post-processing at the output of the deep learning network 807 before the output is provided to the vehicle control module 811.

In some embodiments, the sensors 803 may include one or more sensors. In various embodiments, the sensors 803 may be attached to different positions of the vehicle. The sensors 803 may be oriented in one or more different directions. For example, the sensors 803 may be attached to the front, side, rear, and/or roof of the vehicle to face in different directions such as forward-facing, rear-facing, and side-facing. In some embodiments, the sensors 803 may be image sensors such as high dynamic range cameras. In some embodiments, the sensors 803 include non-visual sensors. In some embodiments, the sensors 803 include radar, LiDAR, and/or ultrasonic sensors in addition to the image sensors. In some embodiments, the sensors 803 are not mounted to a vehicle having the vehicle control module 811. For example, the sensors 803 may be included as part of a deep learning system for capturing sensor data and attached to the environment or road and/or equipped to surrounding vehicles.

In some embodiments, the image pre-processor 805 may be used to pre-process sensor data of the sensors 803. For example, the image pre-processor 805 may be used to pre-process sensor data, split sensor data into one or more components, and/or post-process one or more components. In some embodiments, the image pre-processor 805 may be a graphics processing unit (GPU), a central processing unit (CPU), an image signal processor, or a specialized image processor. In various embodiments, the image pre-processor 805 may be a tone-mapper processor for processing high dynamic range data. In some embodiments, the image pre-processor 805 may be a component of the AI processor 809.

In some embodiments, the deep learning network 807 may be a deep learning network for implementing control commands for controlling an autonomous vehicle. For example, the deep learning network 807 may be an artificial neural network, such as a convolutional neural network (CNN), trained using sensor data, and the output of the deep learning network 807 is provided to the vehicle control module 811.

In some embodiments, the artificial intelligence (AI) processor 809 may be a hardware processor for running the deep learning network 807. In some embodiments, the AI processor 809 is a specialized AI processor for performing inference through a convolutional neural network (CNN) on sensor data. In some embodiments, the AI processor 809 may be optimized for bit depth of sensor data. In some embodiments, the AI processor 809 may be optimized for deep learning operations, such as operations of a neural network including convolution, dot product, vector and/or matrix operations. In some embodiments, the AI processor 809 may be implemented through a plurality of graphics processing devices (GPUs) capable of effectively performing parallel processing.

In various embodiments, the AI processor 809 may be coupled via an input/output interface to memory configured to provide an AI processor having instructions to perform deep learning analysis on sensor data received from the sensor(s) 803 while the AI processor 809 is running and to determine a machine learning result used to operate the vehicle at least partially autonomously. In some embodiments, the vehicle control module 811 may be used to process instructions for vehicle control output from the artificial intelligence (AI) processor 809 and to translate the output of the AI processor 809 into instructions for controlling the modules of each vehicle to control various modules of the vehicle. In some embodiments, the vehicle control module 811 is used to control the vehicle for autonomous driving. In some embodiments, the vehicle control module 811 may adjust the steering and/or speed of the vehicle. For example, the vehicle control module 811 may be used to control the driving of the vehicle, such as deceleration, acceleration, steering, lane change, lane keeping, etc. In some embodiments, the vehicle control module 811 may generate control signals for controlling vehicle lighting, such as brake lights, turn signals, headlights, or the like. In some embodiments, the vehicle control module 811 may be used to control vehicle audio-related systems, such as the vehicle's sound system, the vehicle's audio warnings, the vehicle's microphone system, the vehicle's horn system, or the like.

In some embodiments, the vehicle control module 811 may be used to control notification systems that include warning systems for informing passengers and/or the driver of driving events such as approaching the intended destination or potential collisions. In some embodiments, the vehicle control module 811 may be used to adjust sensors such as the sensors 803 of the vehicle. For example, the vehicle control module 811 may modify the orientation direction of the sensors 803, change the output resolution and/or format type of the sensors 803, increase or decrease the capture rate, adjust the dynamic range, and adjust the focus of the camera. Further, the vehicle control module 811 may individually or collectively turn on/off the operations of the sensors.

In some embodiments, the vehicle control module 811 may be used to change the parameters of the image pre-processor 805 in such a way as modifying the frequency range of filters, adjusting features and/or edge detection parameters for object detection, or adjusting channels and bit depth. In various embodiments, the vehicle control module 811 may be used to control autonomous driving of the vehicle and/or a driver assistance function of the vehicle.

In some embodiments, the network interface 813 may serve as an internal interface between the communication unit 815 and the block components of the autonomous driving system 800. Specifically, the network interface 813 may be a communication interface for receiving and/or transmitting data including voice data. In various embodiments, the network interface 813 may be connected to external servers to connect voice calls through the communication unit 815 or to receive and/or transmit text messages, transmit sensor data, update the software of the vehicle to the autonomous driving system, or update the software of the vehicle's autonomous driving system.

In various embodiments, the communication unit 815 may include various wireless interfaces of cellular or Wi-Fi methods. For example, the network interface 813 may be used to receive an update on operation parameters and/or instructions for the sensors 803, the image pre-processor 805, the deep learning network 807, the AI processor 809, and the vehicle control module 811 from an external server connected through the communication unit 815. For example, the machine learning model of the deep learning network 807 may be updated using the communication unit 815. According to another example, the communication unit 815 may be used to update the operation parameters of the image pre-processor 805, such as image processing parameters, and/or the firmware of the sensors 803.

In another embodiment, the communication unit 815 may be used to activate communication for emergency services and emergency contact in an accident or near-accident event. For example, in a collision event, the communication unit 815 may be used to call emergency services for assistance, and may be used to inform the outside of the collision details and emergency services of the vehicle's position. In various embodiments, the communication unit 815 may update or obtain the expected arrival time and/or destination position.

According to an embodiment, the autonomous driving system 800 shown in FIG. 8 may be configured as an electronic device 101 of a vehicle. According to an embodiment, if an autonomous driving release event occurs from the user during autonomous driving of the vehicle, the AI processor 809 of the autonomous driving system 800 may control to train autonomous driving software of the vehicle by controlling to input information related to the autonomous driving release event as training set data of the deep learning network.

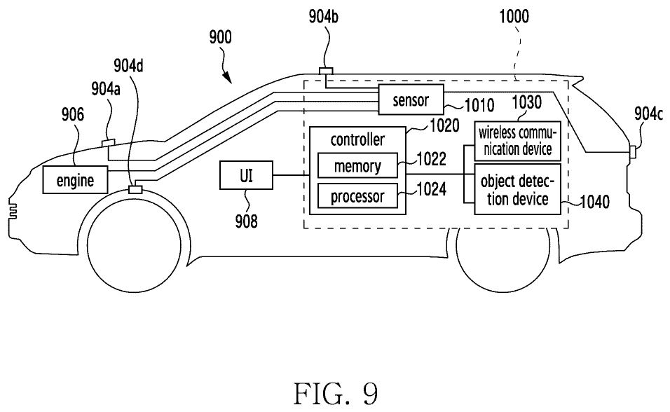

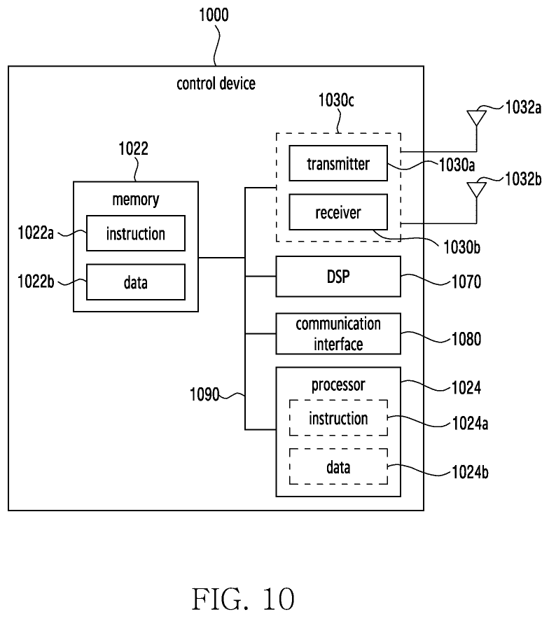

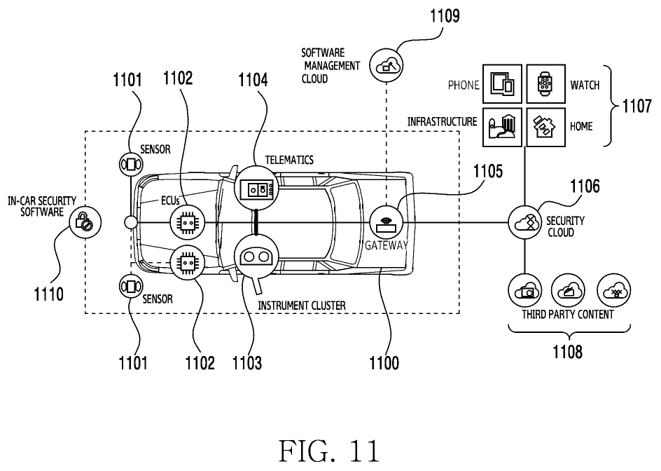

FIGS. 9 and 10 are block diagrams illustrating an example of an autonomous driving moving object according to an embodiment; FIG. 11 illustrates an example of a gateway related to a user device according to various embodiments;

Referring to FIG. 9, an autonomous driving moving object 900 according to the present embodiment may include a control device 1000, sensing modules 904a, 904b, 904c, and 904d, an engine 906, and a user interface 908.

The autonomous driving moving object 900 may have an autonomous driving mode or a manual mode. For example, according to a user input received through the user interface 908, the manual mode may be switched to the autonomous driving mode, or the autonomous driving mode may be switched to the manual mode.

When the autonomous driving moving object 900 is driven in the autonomous driving mode, the autonomous driving moving object 900 may be driven under the control of the control device 1000.

In the present embodiment, the control device 1000 may include a controller 1020 including memory 1022 and a processor 1024, a sensor 1010, a communication device 1030, and an object detection device 1040.

Here, the object detection device 1040 may perform all or some functions of the distance measurement device.

In other words, in the present embodiment, the object detection device 1040 is a device for detecting an object positioned outside the autonomous driving moving object 900, and the object detection device 1040 may detect an object positioned outside the autonomous driving moving object 900 and generate object information according to the detection result.

The object information may include information about the presence or absence of an object, position information about the object, distance information between the moving object and the object, and relative speed information between the moving object and the object.

The object may include various objects positioned outside the autonomous driving moving object 900 such as lanes, other vehicles, pedestrians, traffic signals, light, roads, structures, speed bumps, terrain, animals, or the like. Here, the traffic signal may be a concept including a traffic light, a traffic sign, and a pattern or text drawn on a road surface. Further, the light may be light generated by a lamp provided in another vehicle, light generated by a street lamp, or sunlight.

Further, the structure may be an object positioned around the road and fixed to the ground. For example, structures may include streetlights, street trees, buildings, power poles, traffic lights, and bridges. The terrain may include mountains, hills, or the like.

The object detection device 1040 may include a camera module. The controller 1020 may extract object information from an external image captured by the camera module and allow the controller 1020 to process the information.

Further, the object detection device 1040 may further include imaging devices for recognizing an external environment. In addition to LIDAR, RADAR, GPS devices, odometry, and other computer vision devices, ultrasonic sensors, and infrared sensors may be used, and these devices may be selected or operated simultaneously as needed to enable more precise detection.

Meanwhile, the distance measurement device according to an embodiment of the disclosure may calculate a distance between the autonomous driving moving object 900 and the object, and control the operation of the moving object based on the calculated distance in connection with the control device 1000 of the autonomous driving moving object 900.

For example, when there is a possibility of collision according to the distance between the autonomous driving moving object 900 and the object, the autonomous driving moving object 900 may control the brake to reduce the speed or stop. As another example, when the object is a moving object, the autonomous driving moving object 900 may control the driving speed of the autonomous driving moving object 900 to maintain a predetermined distance or more from the object.

The distance measurement device according to an embodiment of the disclosure may be configured as a module in the control device 1000 of the autonomous driving moving object 900. In other words, the memory 1022 and the processor 1024 of the control device 1000 may implement the collision prevention method according to the disclosure in software.

Further, the sensor 1010 may be connected to the sensing modules 904a, 904b, 904c, and 904d in the internal/external environment of the moving object to obtain various pieces of information. Here, the sensor 1010 may include a posture sensor (e.g., a yaw sensor), a roll sensor, a pitch sensor, a collision sensor, a wheel sensor, a speed sensor, a tilt sensor, a weight detection sensor, a heading sensor, a gyro sensor, a position module, a moving object forward/reverse sensor, a battery sensor, a fuel sensor, a tire sensor, a steering sensor according to the rotation of the steering wheel, a moving object internal temperature sensor, a moving object internal humidity sensor, an ultrasonic sensor, an illumination sensor, an accelerator pedal position sensor, a brake pedal position sensor, or the like.

Accordingly, the sensor 1010 may obtain sensing signals for moving object posture information, moving object collision information, moving object direction information, moving object position information (GPS information), moving object angle information, moving object speed information, moving object acceleration information, moving object slope information, moving object forward/rearward information, battery information, fuel information, tire information, moving object lamp information, moving object internal temperature information, moving object internal humidity information, steering wheel rotation angle, moving object external illumination, pressure applied to the accelerator pedal, pressure applied to the brake pedal, or the like.

Further, the sensor 1010 may further include an accelerator pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), or the like.

As such, the sensor 1010 may generate moving object state information based on the sensing data.

The wireless communication device 1030 is configured to implement wireless communication between the autonomous driving moving objects 900. For example, it allows the autonomous driving moving object 900 to communicate with the user's mobile phone or another wireless communication device 1030, another moving object, a central device (traffic control device), a server, etc. The wireless communication device 1030 may transmit and receive wireless signals according to an access wireless protocol. The wireless communication protocol may be Wi-Fi, Bluetooth, long-term evolution (LTE), code division multiple access (CDMA), wideband code division multiple access (WCDMA), and global systems for mobile communications (GSM), but the communication protocols are not limited thereto.

Further, in the present embodiment, the autonomous driving moving object 900 may implement communication between moving objects through the wireless communication device 1030. In other words, the wireless communication device 1030 may communicate with other moving objects and other moving objects on the road through vehicle-to-vehicle communication (V2V) communication. The autonomous driving moving object 900 may transmit and receive information such as a driving warning and traffic information through vehicle-to-vehicle communication, and may send or receive a request for information to/from another moving object. For example, the wireless communication device 1030 may perform V2V communication by a short-range communication (dedicated short-range communication (DSRC)) device or a cellular-V2V (C-V2V) device. In addition to vehicle-to-vehicle communication, communication between the vehicle and another object (e.g., an electronic device carried by a pedestrian) (vehicle-to-everything (V2X) communication)) may also be implemented through the wireless communication device 1030.

Further, the wireless communication device 1030 may obtain information generated by infrastructures (traffic lights, CCTVs, RSUs, eNode Bs, etc.) positioned on the road or various mobilities including other autonomous driving/non-autonomous driving vehicles, as information for performing autonomous driving by the autonomous driving moving object 900 through a non-terrestrial network rather than a terrestrial network.

For example, the wireless communication device 1030 may perform wireless communication with a low-earth orbit (LEO) satellite system, a medium-earth orbit (MEO) satellite system, a geostationary orbit (GEO) satellite system, or a high altitude platform (HAP) system constituting non-terrestrial networks through a non-terrestrial network-dedicated antenna mounted on the autonomous driving moving object 900.

For example, the wireless communication device 1030 may perform wireless communication with various platforms constituting an NTN according to a radio access standard according to the fifth-generation new radio non-terrestrial network (5G NR NTN) standard, which is currently being discussed in the 3GPP.

In the present embodiment, the controller 1020 may select a platform capable of properly performing NTN communication considering various pieces of information such as the position, current time, and available power of the autonomous driving moving object 900, and control the wireless communication device 1030 to perform wireless communication with the selected platform.

In the present embodiment, the controller 1020 is a unit that controls the overall operation of each unit in the autonomous driving moving object 900, and may be configured at the time of manufacture by the manufacturer of the moving object or may be additionally configured to perform an autonomous driving function after manufacturing. Alternatively, a configuration for performing consecutive additional functions may be included through an upgrade of the controller 1020 configured at the time of manufacture. The controller 1020 may be referred to as an electronic control unit (ECU).

The controller 1020 may collect various data from the connected sensor 1010, the object detection device 1040, the communication device 1030, and transfer control signals to the sensor 1010, the engine 906, the user interface 908, the communication device 1030, and the object detection device 1040 included as other components in the moving object based on the collected data. Further, although not shown, control signals may also be transferred to the acceleration device, braking system, steering device, or navigation device related to the driving of the moving object.

In the present embodiment, the controller 1020 may control the engine 906 and, for example, detect the speed limit of the road where the autonomous driving moving object 900 is driving and control the engine 906 so that the driving speed does not exceed the speed limit or control the engine 906 to accelerate the driving speed of the autonomous driving moving object 900 within a range in which the speed limit is not exceeded.

Further, if the autonomous driving moving object 900 is approaching or leaving the lane while the autonomous driving moving object 900 is driving, the controller 1020 determines whether approaching and leaving the lane are based on a normal driving situation or other driving conditions, and controls the engine 906 to control the driving of the moving object according to the determination result. Specifically, the autonomous driving moving object 900 may detect the lanes formed on two opposite sides of the lane where the moving object is driving. In this case, the controller 1020 may determine whether the autonomous driving moving object 900 is approaching or leaving the lane and, if determining that the autonomous driving moving object 900 is approaching or leaving the lane, determine whether such driving is due to an accurate driving circumstance or another driving circumstance. Here, an example of the normal driving circumstance may be a circumstance where the vehicle needs to change lanes. An example of the other driving circumstance may be a circumstance where the vehicle need not change lanes. If the controller 1020 determines that the autonomous driving moving object 900 is approaching or leaving the lane in a circumstance where the lane change of the moving object is not required, the controller 1020 may control the driving of the autonomous driving moving object 900 so that the autonomous driving moving object 900 does not leave the lane but drives normally.

If there is another moving object or obstruction in front of the moving object, the engine 906 or the braking system may be controlled to decelerate the driving moving object and, in addition to speed, the trajectory, driving route, and steering angle may be controlled. Alternatively, the controller 1020 may control the driving of the moving object by generating necessary control signals according to recognition information about other external environments such as driving lanes and driving signals of the moving object.

In addition to generating its own control signal, the controller 1020 may control the driving of the moving object by performing communication with a peripheral moving object or a central server and transmitting a command for controlling peripheral devices through the received information.

Further, when the position of the camera module is changed or the angle of view is changed, it may be impossible to accurately recognize the moving object or lane according to the present embodiment. Thus, to prevent such issue, the controller 1020 may generate a control signal to control to perform calibration on the camera module. Therefore, in the present embodiment, the controller 1020 may generate a calibration control signal to the camera module to maintain the normal mounting position, direction, and angle of view of the camera module even when the mounting position of the camera module is changed by vibration or impact generated by the movement of the autonomous driving moving object 900. The controller 1020 may generate a control signal to perform calibration on the camera module when the pre-stored initial mounting position, direction, and angle-of-view information about the camera module and the initial mounting position, direction, and angle-of-view information about the camera module measured during the driving of the autonomous driving moving object 900 are varied by a threshold or more.

In the present embodiment, the controller 1020 may include memory 1022 and a processor 1024. The processor 1024 may execute the software stored in the memory 1022 according to a control signal from the controller 1020. Specifically, the controller 1020 stores data and instructions for performing the lane detection method according to the disclosure in the memory 1022, and the instructions may be executed by the processor 1024 to implement one or more methods disclosed herein.

In this case, the memory 1022 may be stored in a non-volatile recording medium executable by the processor 1024. The memory 1022 may store software and data through a suitable internal/external device. The memory 1022 may be composed of a random access memory (RAM), a read only memory (ROM), a hard disk, and a memory device 1022 connected to a dongle.

The memory 1022 may store, at least, an operating system (OS), user applications, and executable commands. The memory 1022 may also store application data and array data structures.

The processor 1024 may be a controller as a microprocessor or an appropriate electronic processor, a micro controller, or a state machine.

The processor 1024 may be implemented as a combination of computing devices, and the computing device may be composed of a digital signal processor, a microprocessor, or an appropriate combination thereof.

Meanwhile, the autonomous driving moving object 900 may further include a user interface 908 for the user's input to the above-described control device 1000. The user interface 908 may allow the user to enter information through appropriate interaction. For example, it may be implemented as a touch screen, a keypad, an operation button, or the like. The user interface 908 may transmit an input or command to the controller 1020, and the controller 1020 may perform a control operation of the moving object in response to the input or command.

Further, the user interface 908 may communicate with the autonomous driving moving object 900 through the wireless communication device 1030 as a device outside the autonomous driving moving object 900. For example, the user interface 908 may enable interworking with a mobile phone, tablet, or other computer devices.

Further, although the autonomous driving moving object 900 includes the engine 906 in the present embodiment, other types of propulsion systems. For example, the moving object may be operated by electrical energy, and may be operated by hydrogen energy or a hybrid system in combination thereof. Therefore, the controller 1020 may include a propulsion mechanism according to the propulsion system of the autonomous driving moving object 900, and may provide a control signal according thereto to the components of each propulsion mechanism.

Hereinafter, a detailed configuration of a control device 1000 according to the present embodiment is described in more detail with reference to FIG. 10.

The control device 1000 includes a processor 1024. The processor 1024 may be a general-purpose single or multi-chip microprocessor, a dedicated microprocessor, a microprocessor, a programmable gate array, or the like. The processor may be referred to as a central processing unit (CPU). Further, in the present embodiment, processor 1024 may be used as a combination of multiple processors.

The control device 1000 also includes memory 1022. The memory 1022 may be any electronic component capable of storing electronic information. The memory 1022 may include a combination of the memories 1022 as well as a single memory.

Data 1022b and instructions 1022a for performing the distance measuring method of the distance measurement device according to the disclosure may be stored in the memory 1022. When the processor 1024 executes the instructions 1024a, all or some of the instructions 1024a and the data 1024b required to execute the instructions 1422a may be loaded on the processor 1024.

The control device 1000 may include a transmitter 1030a, a receiver 1030b, or a transceiver 1030c for allowing transmission and reception of signals. One or more antennas 1032a and 1032b may be electrically connected to the transmitter 1030a, the receiver 1030b, or each transceiver 1030c, and may additionally include antennas.

The control device 1000 may include a digital signal processor (DSP) 1070. The DSP 1070 may allow the moving object to quickly process the digital signal.

The control device 1000 may include a communication interface 1080. The communication interface 1080 may include one or more ports and/or communication modules for connecting other devices to the control device 1000. The communication interface 1080 may enable the user and the control device 1000 to interact with each other.

Various components of the control device 1000 may be connected together by one or more buses 1090, and the buses 1090 may include a power bus, a control signal bus, a status signal bus, a data bus, or the like. Under the control of the processor 1024, the components may transfer information therebetween through the bus 1090 and perform a desired function.

Meanwhile, in various embodiments, the control device 1000 may be related to a gateway for communication with a secure cloud. For example, referring to FIG. 11, the control device 1000 may be related to the gateway 1105 for providing information obtained from at least one of the components 1101 to 1104 of the vehicle 1100 to the secure cloud 1106. For example, the gateway 1105 may be included in the control device 1000. As another example, the gateway 1105 may be configured as a separate device within the vehicle 1100 that is distinguished from the control device 1000. The gateway 1105 communicatively connects a software management cloud 1109, a secure cloud 1106, and a network in the vehicle 1100 secured by in-vehicle security software 1110 having different networks.

For example, the component 1101 may be a sensor. For example, the sensor may be used to obtain information about at least one of the state of the vehicle 1100 or the state around the vehicle 1100. For example, the component 1101 may include a sensor 1010.

For example, the component 1102 may be an electronic control unit (ECU). For example, the ECUs may be used for engine control, transmission control, airbag control, tire pressure management.

For example, the component 1103 may be an instrument cluster. For example, the instrument cluster may refer to a panel positioned in front of the driver's seat in the dashboard. For example, the instrument cluster may be configured to show the driver (or passenger) the information necessary for driving. For example, the instrument cluster may be used to display at least one of visual elements to indicate the engine's revolutions per minute or rotations per minute (RPM), visual elements to indicate the speed of the vehicle 1100, visual elements to indicate the amount of remaining fuel, visual elements to indicate the state of the gear, or visual elements to indicate information obtained through the component 1101.

For example, the component 1104 may be a telematics device. For example, the telematics device may refer to a device that combines wireless communication technology and global positioning system (GPS) technology to provide various mobile communication services such as location information and safe driving within the vehicle 1100. For example, the telematics device may be used to connect the driver, a cloud (e.g., the secure cloud 1106), and/or the ambient environment and the vehicle 1100. For example, the telematics device may be configured to support high bandwidth and low latency for 5G NR-standard technology (e.g., 5G NR V2X technology, 5G NR's non-terrestrial network (NTN) technology). For example, the telematics device may be configured to support autonomous driving of the vehicle 1100.

For example, the gateway 1105 may be used to connect the software management cloud 1109 and the secure cloud 1106, which are an in-vehicle (1100) network and an out-of-vehicle network. For example, the software management cloud 1109 may be used to update or manage at least one software required for driving and managing the vehicle 1100. For example, the software management cloud 1109 may be linked to in-vehicle (or in-car) security software 1110 installed in the vehicle. For example, the in-vehicle security software 1110 may be used to provide a security function within vehicle 1100. For example, the in-vehicle security software 1110 may encrypt data transmitted and received through an in-vehicle network using an encryption key obtained from an external authorized server for encryption of the in-vehicle network. In various embodiments, the encryption key used by the in-vehicle security software 1110 may be generated corresponding to vehicle identification information (vehicle license plate, vehicle identification number (VIN)) or information uniquely assigned to each user (user identification information).

In various embodiments, the gateway 1105 may transmit data encrypted by the in-vehicle security software 1110 based on the encryption key to the software management cloud 1109 and/or the secure cloud 1106. The software management cloud 1109 and/or the secure cloud 1106 may identify the data received from which vehicle or from which user by decrypting the data encrypted by the encryption key of the in-vehicle security software 1110 using a decryption key capable of decrypting the encrypted data. For example, since the decryption key is a unique key corresponding to the encryption key, the software management cloud 1109 and/or the secure cloud 1106 may identify the transmission entity (e.g., the vehicle or the user) of the data based on the data decrypted through the decryption key.

For example, the gateway 1105 is configured to support the in-vehicle security software 1110 and may be related to the control device 1000. For example, the gateway 1105 may be related to the control device 1000 to support the connection between the client device 1107 connected to the secure cloud 1106 and the control device 1000. As another example, the gateway 1105 may be related to the control device 1000 to support the connection between the third-party cloud 1108 connected to the secure cloud 1106 and the control device 1000. However, the disclosure is not limited thereto.

In various embodiments, the gateway 1105 may be used to connect the vehicle 1100 with the software management cloud 1109 for managing the operating software of the vehicle 1100. For example, the software management cloud 1109 may monitor whether the operating software of the vehicle 1100 is updated and provide data for updating the operating software of the vehicle 1100 through the gateway 1105 based on monitoring that the operating software of the vehicle 1100 is required to be updated. As another example, the software management cloud 1109 may receive a user request for updating the operating software of the vehicle 1100 from the vehicle 1100 through the gateway 1105, and provide data for updating the operating software of the vehicle 1100 based on the reception. However, the disclosure is not limited thereto.

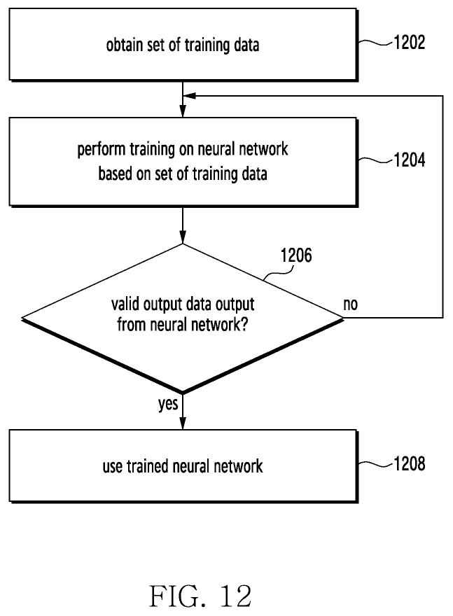

FIG. 12 is a view illustrating operations of an electronic device training a neural network based on a set of training data according to an embodiment.

The operations described with reference to FIG. 12 may be performed by the above-described electronic device (e.g., the electronic device 101 of FIG. 1).

Referring to FIG. 12, in operation 1202, the electronic device may obtain a set of training data according to an embodiment. The electronic device may obtain a set of training data for supervised learning. The training data may include a pair of input data and ground truth data corresponding to the input data. The ground truth data may indicate output data to be obtained from a neural network that has received input data, which forms the pair with the ground truth data. The ground truth data may be obtained by the above-described electronic device.

For example, when training the neural network for image recognition, the training data may include images and information about one or more subjects included in the images. The information may include the category or class of subjects identifiable through the image. The information may include the position, width, height, and/or size of the visual object corresponding to the subject in the image. The set of training data identified through operation 1202 may include pairs of a plurality of training data. In the example of training the neural network for image recognition, the set of training data identified by the electronic device may include a plurality of images and ground truth data corresponding to each of the plurality of images.

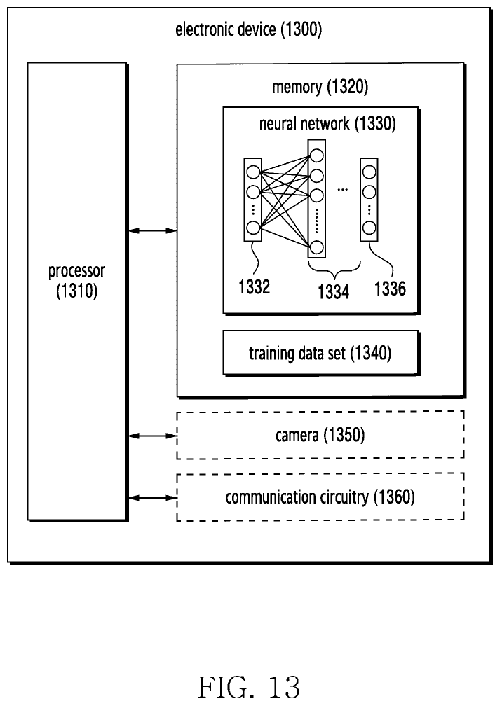

Referring to FIG. 12, in operation 1204, the electronic device according to an embodiment may perform training on the neural network based on the set of training data. In an embodiment in which the neural network is trained based on supervised learning, the electronic device may input input data included in the training data to the input layer of the neural network. An example of the neural network including the input layer is described with reference to FIG. 13. From the output layer of the neural network receiving the input data through the input layer, the electronic device may obtain output data of the neural network corresponding to the input data.

In an embodiment, the training of operation 1204 may be performed based on a difference between the output data and the ground truth data included in the training data and corresponding to the input data. For example, the electronic device may adjust one or more parameters (e.g., weights described below with reference to FIG. 13) related to the neural network to reduce the difference based on a gradient descent algorithm. The operation of the electronic device adjusting the one or more parameters may be referred to as tuning of the neural network. The electronic device may perform tuning of the neural network based on output data using a function defined to evaluate the performance of the neural network, such as a cost function. The difference between the above-described output data and the ground truth data may be included as an example of the cost function.

Referring to FIG. 12, in operation 1206, according to an embodiment, the electronic device may identify whether valid output data is output from the neural network trained in operation 1204. That the output data is valid may mean that the difference (or cost function) between the output data and the ground truth data meets a condition set for use of the neural network. For example, when the average and/or maximum value of the difference between the output data and the ground truth data is less than or equal to a designated threshold, the electronic device may determine that valid output data is output from the neural network.

When valid output data is not output from the neural network (No in 1206), the electronic device may repeatedly perform training of the neural network based on operation 1204. The embodiments are not limited thereto, and the electronic device may repeatedly perform operations 1202 and 1204.

In a state in which valid output data is obtained from the neural network (Yes in 1206), based on operation 1208, the electronic device according to an embodiment may use the trained neural network. For example, the electronic device may input other input data distinct from the input data input to the neural network as training data, to the neural network. The electronic device may use the output data obtained from the neural network receiving the other input data as a result of performing inference on the other input data based on the neural network.

FIG. 13 is a block diagram illustrating an electronic device according to an embodiment.

The electronic device 1300 of FIG. 13 may include the above-described electronic device.

For example, the operations described with reference to FIG. 12 may be performed by the electronic device 1300 of FIG. 13 and/or the processor 1310 of FIG. 13.

Referring to FIG. 13, the processor 1310 of the electronic device 1300 may perform computations related to the neural network 1330 stored in the memory 1320. The processor 1310 may include at least one of a center processing unit (CPU), a graphic processing unit (GPU), and a natural processing unit (NPU). The NPU may be implemented as a chip separated from the CPU, or integrated into a chip such as a CPU in the form of a system on chip (SoC). The NPU integrated into the CPU may be referred to as a neural core and/or an artificial intelligence (AI) accelerator.

Referring to FIG. 13, the processor 1310 may identify the neural network 1330 stored in the memory 1320. The neural network 1330 may include a combination of an input layer 1332, one or more hidden layers 1334 (or intermediate layers), and an output layer 1336. The above-described layers (e.g., the input layer 1332, the one or more hidden layers 1334, and the output layer 1336) may include a plurality of nodes. The number of hidden layers 1334 may vary according to an embodiment, and a neural network 1330 including the plurality of hidden layers 1334 may be referred to as a deep neural network. The operation of training the deep neural network may be referred to as deep learning.

In an embodiment, when the neural network 1330 has a structure of a feed forward neural network, the first node included in a specific layer may be connected to all of the second nodes included in other layers before the specific layer. Parameters stored for the neural network 1330 in the memory 1320 may include weights assigned to connections between the second nodes and the first node. In the neural network 1330 having a structure of a feed forward neural network, the value of the first node may correspond to a weighted sum of values allocated to the second nodes, based on the weights assigned to connections connecting the second nodes and the first node.

In an embodiment, when the neural network 1330 has a structure of a convolutional neural network, the first node included in a specific layer may correspond to a weighted sum of some of the second nodes included in other layers before the specific layer. Some of the second nodes corresponding to the first node may be identified by a filter corresponding to the specific layer. The parameters stored for the neural network 1330 in the memory 1320 may include weights indicating the filter. The filter may include, among the second nodes, one or more nodes to be used to calculate the weighted sum of the first node, and weights respectively corresponding to the one or more nodes.

According to an embodiment, the processor 1310 of the electronic device 1300 may perform training on the neural network 1330 using the training data set 1340 stored in the memory 1320. Based on the training data set 1340, the processor 1310 may perform the operations described with reference to FIG. 12 to adjust one or more parameters stored in the memory 1320 for the neural network 1330.

According to an embodiment, the processor 1310 of the electronic device 1300 may perform object detection, object recognition, and/or object classification using the neural network 1330 trained based on the training data set 1340. The processor 1310 may input the image (or video) obtained through the camera 1350 into the input layer 1332 of the neural network 1330. Based on the input layer 1332 to which the image is input, the processor 1310 may sequentially obtain the values of nodes of layers included in the neural network 1330 to obtain a set (e.g., output data) of values of nodes of the output layer 1336. The output data may be used as a result of inferring information included in the image using the neural network 1330. The embodiments are not limited thereto, and the processor 1310 may input the image (or video) obtained from the external electronic device connected to the electronic device 1300 through the communication circuitry 1360 into the neural network 1330.

In an embodiment, the neural network 1330 trained to process the image may be used to identify the region corresponding to the subject in the image (object detection), and/or to identify the class of the subject represented in the image (object recognition and/or object classification). For example, the electronic device 1300 may segment the region corresponding to the subject in the image based on a rectangular shape such as a bounding box using the neural network 1330. For example, the electronic device 1300 may identify at least one class matching the subject among a plurality of designated classes using the neural network 1330.

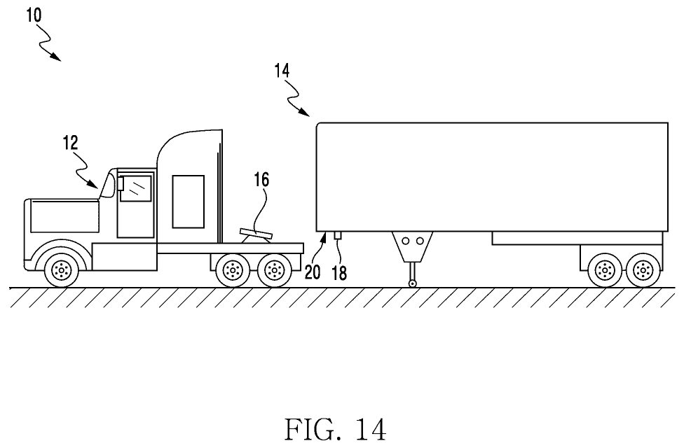

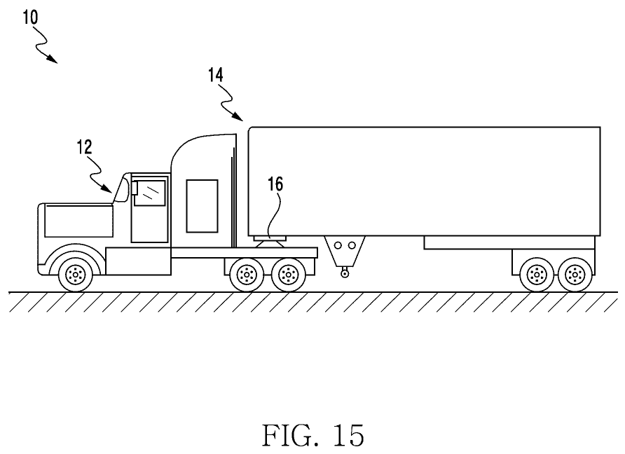

A conventional truck 10 is illustrated in FIGS. 14 and 15.

FIG. 14 illustrates a state in which the tractor 12 and the trailer 14 are not connected.

FIG. 15 illustrates a state in which the tractor 12 and the trailer 14 are connected. In an embodiment of the disclosure, the trailer 14 is selectively connected by a fifth wheel hitch 16 carried by the tractor 12, which engages the kingpin 18 fixed to the trailer 14 in a known manner.

The trailer 20 shown in FIG. 14 of the disclosure is illustrated as a “semi-trailer”, but this is for convenience of description, and it should not be understood that the embodiments of the disclosure are applied only to a “semi-trailer” form.

As described above, the electronic device 101 may comprise communication circuitry 110. The electronic device 101 may comprise memory 130 storing instructions. The electronic device 101 may comprise at least one processor 120 operably coupled to the communication circuitry 110, and the memory 130. The instructions may, when executed by the processor 120, cause the electronic device 101 to obtain, through the communication circuitry 110, first images 211 to 220 from a first camera 151. The instructions may, when executed by the processor 120, cause the electronic device 101 to obtain, through the communication circuitry 110, second images 221 to 230 from a second camera 155 of which a shutter speed is slower than a shutter speed of the first camera 151. The instructions may, when executed by the processor 120, cause the electronic device 101 to identify a first image 211 and a second image 221 obtained at corresponding times from the first images 211 to 220 and the second images 221 to 230. The instructions may, when executed by the processor 120, cause the electronic device 101 to set a first region of interest (ROI) 540 of an object with a specified type in the first image 211. The instructions may, when executed by the processor 120, cause the electronic device 101 to set a second ROI 640 at the same position as the first ROI 540 in the second image 221. The instructions may, when executed by the processor 120, cause the electronic device 101 to generate the first image 211 with the first ROI 540 set and the second image with the second ROI 640 set as training data.

In an embodiment, the second camera 155 may be arranged to have an angle corresponding to an angle of the first camera 151. In an embodiment, a lens property of the second camera 155 may be identical to a lens property of the first camera 151. The instructions may, when executed by the processor 120, cause the electronic device 101 to instruct the first camera 151 and the second camera 155 to take pictures at corresponding times.

The instructions may, when executed by the processor 120, cause the electronic device 101 to, after instructing the first camera 151 and the second camera 155 to take pictures at corresponding times, obtain the first images 211 to 220 and the second images 221 to 230 for a specified time. The instructions may, when executed by the processor 120, cause the electronic device 101 to, based on comparing a reference image (e.g., the image 215) among the first images 211 to 220 and each of the second images 221 to 230, identify an image obtained at a corresponding time with the reference image (e.g., the image 215). The instructions may, when executed by the processor 120, cause the electronic device 101 to identify the second image from the second images 221 to 230, which has a frame difference equal to a frame difference from the first image 211 to the reference image (e.g., the image 215), from the second images 221 to 230.

The instructions may, when executed by the processor 120, cause the electronic device 101 to in the first image 211, generate a cropped first image by cropping a region 410 of a specified size. The instructions may, when executed by the processor 120, cause the electronic device 101 to cause the electronic device 101 to, based on the cropped first image 211, generate a cropped second image 221 by cropping another region 430 of a specified size in the second image 221.

The instructions may, when executed by the processor 120, cause the electronic device 101 to identify normalized differences between a plurality of regions of the cropped first image 211 and the second image 221. The instructions may, when executed by the processor 120, cause the electronic device 101 to identify normalized distances between feature points of the cropped first image 211 and feature points of each of the plurality of regions of the second image 221. The instructions may, when executed by the processor 120, cause the electronic device 101 to generate the cropped second image 221, by cropping a region where a weighted average between the normalized differences and the normalized distances may be the lowest.

The instructions may, when executed by the processor 120, cause the electronic device 101 to, in the cropped first image 211, identify an object with a specified type. The instructions may, when executed by the processor 120, cause the electronic device 101 to set the first ROI 540 within the object identified in the cropped first image 211. The instructions may, when executed by the processor 120, cause the electronic device 101 to set the position of the object in the cropped first image 211 in the cropped second image 221. The instructions may, when executed by the processor 120, cause the electronic device 101 to set the second ROI 640 in the same position as the first ROI 540 in the cropped first image 211 in the cropped second image 221.

The instructions may, when executed by the processor 120, cause the electronic device 101 to, in the first ROI 540, based on a string identification algorithm, identify a string. The instructions may, when executed by the processor 120, cause the electronic device 101 to label the identified string in the first ROI 540 and the second ROI 640.

The instructions may, when executed by the processor 120, cause the electronic device 101 to convert the first ROI 540 into a specified shape based on a specified transformation algorithm. The instructions may, when executed by the processor 120, cause the electronic device 101 to identify the string based on the string identification algorithm in the first ROI 540 converted into the specified shape.

The instructions may, when executed by the processor 120, cause the electronic device 101 to, based on a difference between consecutive images among the first images 211 to 220, identify whether the electronic device 101 may be moved. The instructions may, when executed by the processor 120, cause the electronic device 101 to, based on the electronic device 101 not being moved, delete the first images 211 to 220 and the second images 221 to 230. The instructions may, when executed by the processor 120, cause the electronic device 101 to, based on the electronic device 101 being moved, generate the training data based on the first images 211 to 220 and the second images 221 to 230.

The above-described method may be executed by an electronic device 101 including communication circuitry 110. The method may comprise obtaining first images 211 to 220 from a first camera 151 through the communication circuitry 110. The method may comprise obtaining, through the communication circuitry 110, second images 221 to 230 from a second camera 155 of which shutter speed may be slower than the shutter speed of the first camera 151. The method may comprise identifying a first image 211 and a second image 221 obtained at corresponding times from the first images 211 to 220 and the second images 221 to 230. The method may comprise setting a first region of interest (ROI) 540 of an object with a specified type in the first image 211. The method may comprise setting a second ROI 640 at the same position as the first ROI 540 in the second image 221. The method may comprise generating the first image 211 with the first ROI 540 set and the second image 221 with the second ROI 640 set as training data.

The method may comprise, after instructing the first camera 151 and the second camera 155 to take pictures at corresponding times, obtaining the first images 211 to 220 and the second images 221 to 230 for a specified time. The method may comprise, based on comparing a reference image among the first images 211 to 220 and each of the second images 221 to 230, identifying an image obtained at a corresponding time with the reference image (e.g., 215). The method may comprise identifying the second image from the second images 221 to 230, which has a frame difference equal to a frame difference from the first image 211 to the reference image (e.g., the image 215), from the second images 221 to 230.

The method may comprise, in the first image, generating a cropped first image 211 by cropping region 410 of a specified size. The method may comprise, based on the cropped first image 211, generating a cropped second image 221 by cropping another region 430 of a specified size in the second image 221.

The method may comprise identifying normalized differences between a plurality of regions of the cropped first image 211 and the second image 221. The method may comprise identifying normalized distances between feature points of the cropped first image 211 and feature points of each of the plurality of regions of the second image 221. The method may comprise generating the cropped second image 221, by cropping a region where a weighted average between the normalized differences and the normalized distances may be the lowest.

The method may comprise, in the cropped first image 211, identifying an object with a specified type. The method may comprise setting the first ROI 540 within the object identified in the cropped first image 211. The method may comprise setting the position of the object in the cropped first image 211 in the cropped second image 221. The method may comprise setting the second ROI 640 in the same position as the first ROI 540 in the cropped first image 211 in the cropped second image 221.

The method may comprise, based on a difference between consecutive images among the first images 211 to 220, identifying whether the electronic device 101 may be moved. The method may comprise, based on the electronic device 101 not being moved, deleting the first images 211 to 220 and the second images 221 to 230. The method may comprise, based on the electronic device 101 being moved, generating the training data based on the first images 211 to 220 and the second images 221 to 230.

As described above, a non-transitory, computer-readable storage medium may store a program including instructions. The instructions may, when executed by a processor 120 of an electronic device 101 including communication circuitry 110, cause the electronic device 101 to obtain, through the communication circuitry 110, first images 211 to 220 from a first camera 151. The instructions may, when executed by the processor 120, cause the electronic device 101 to obtain, through the communication circuitry 110, second images 221 to 230 from a second camera 155 of which a shutter speed is slower than a shutter speed of the first camera 151. The instructions may, when executed by the processor 120, cause the electronic device 101 to identify a first image 211 and a second image 221 obtained at corresponding times from the first images 211 to 220 and the second images 221 to 230. The instructions may, when executed by the processor 120, cause the electronic device 101 to set a first region of interest (ROI) 540 of an object with a specified type in the first image 211. The instructions may, when executed by the processor 120, cause the electronic device 101 to set a second ROI 640 at the same position as the first ROI 540 in the second image 221. The instructions may, when executed by the processor 120, cause the electronic device 101 to generate the first image 211 with the first ROI 540 set and the second image with the second ROI 640 set as training data.

The instructions may, when executed by the processor 120, cause the electronic device 101 to in the first image 211, generate a cropped first image by cropping region 410 of a specified size. The instructions may, when executed by the processor 120, cause the electronic device 101 to cause the electronic device 101 to, based on the cropped first image 211, generate a cropped second image 221 by cropping another region 430 of a specified size in the second image 221.

The instructions may, when executed by the processor 120, cause the electronic device 101 to identify normalized differences between a plurality of regions of the cropped first image 211 and the second image 221. The instructions may, when executed by the processor 120, cause the electronic device 101 to identify normalized distances between feature points of the cropped first image 211 and feature points of each of the plurality of regions of the second image 221. The instructions may, when executed by the processor 120, cause the electronic device 101 to generate the cropped second image 221, by cropping a region where a weighted average between the normalized differences and the normalized distances may be the lowest.

The instructions may, when executed by the processor 120, cause the electronic device 101 to, in the cropped first image 211, identify an object with a specified type. The instructions may, when executed by the processor 120, cause the electronic device 101 to set the first ROI 540 within the object identified in the cropped first image 211. The instructions may, when executed by the processor 120, cause the electronic device 101 to set the position of the object in the cropped first image 211 in the cropped second image 221. The instructions may, when executed by the processor 120, cause the electronic device 101 to set the second ROI 640 in the same position as the first ROI 540 in the cropped first image 211 in the cropped second image 221.

The instructions may, when executed by the processor 120, cause the electronic device 101 to, based on a difference between consecutive images among the first images 211 to 220, identify whether the electronic device 101 may be moved. The instructions may, when executed by the processor 120, cause the electronic device 101 to, based on the electronic device 101 not being moved, delete the first images 211 to 220 and the second images 221 to 230. The instructions may, when executed by the processor 120, cause the electronic device 101 to, based on the electronic device 101 being moved, generate the training data based on the first images 211 to 220 and the second images 221 to 230.

As described above, an electronic device 101 may comprise 151 and 155. The electronic device 101 may comprise memory 130 storing instructions. The electronic device 101 may comprise at least one processor 120 operably coupled to the cameras 151 and 155, and the memory 130. The instructions may, when executed by the processor 120, cause the electronic device 101 to obtain first images 211 to 220 from a first camera 151. The instructions may, when executed by the processor 120, cause the electronic device 101 to obtain second images 221 to 230 from a second camera 155 of which a shutter speed is slower than a shutter speed of the first camera 151. The instructions may, when executed by the processor 120, cause the electronic device 101 to identify a first image 211 and a second image 221 obtained at corresponding times from the first images 211 to 220 and the second images 221 to 230. The instructions may, when executed by the processor 120, cause the electronic device 101 to set a first region of interest (ROI) 540 of an object with a specified type in the first image 211. The instructions may, when executed by the processor 120, cause the electronic device 101 to set a second ROI 640 at the same position as the first ROI 540 in the second image 221. The instructions may, when executed by the processor 120, cause the electronic device 101 to generate the first image 211 with the first ROI 540 set and the second image with the second ROI 640 set as training data.

The above-described method may be executed by an electronic device 101 including cameras 151 and 155. The method may comprise obtaining first images 211 to 220 from a first camera 151. The method may comprise obtaining second images 221 to 230 from a second camera 155 of which shutter speed may be slower than the shutter speed of the first camera 151. The method may comprise identifying a first image 211 and a second image 221 obtained at corresponding times from the first images 211 to 220 and the second images 221 to 230. The method may comprise setting a first region of interest (ROI) 540 of an object with a specified type in the first image 211. The method may comprise setting a second ROI 640 at the same position as the first ROI 540 in the second image 221. The method may comprise generating the first image 211 with the first ROI 540 set and the second image 221 with the second ROI 640 set as training data.

As described above, a non-transitory, computer-readable storage medium may store a program including instructions. The instructions may, when executed by a processor 120 of an electronic device 101 including cameras 151 and 155, cause the electronic device 101 to obtain first images 211 to 220 from a first camera 151. The instructions may, when executed by the processor 120, cause the electronic device 101 to obtain second images 221 to 230 from a second camera 155 of which a shutter speed is slower than a shutter speed of the first camera 151. The instructions may, when executed by the processor 120, cause the electronic device 101 to identify a first image 211 and a second image 221 obtained at corresponding times from the first images 211 to 220 and the second images 221 to 230. The instructions may, when executed by the processor 120, cause the electronic device 101 to set a first region of interest (ROI) 540 of an object with a specified type in the first image 211. The instructions may, when executed by the processor 120, cause the electronic device 101 to set a second ROI 640 at the same position as the first ROI 540 in the second image 221. The instructions may, when executed by the processor 120, cause the electronic device 101 to generate the first image 211 with the first ROI 540 set and the second image with the second ROI 640 set as training data.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

According to embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

Although specific embodiments of the disclosure have been described above, various changes may be made thereto without departing from the scope of the disclosure.

What is claimed is:

1. An electronic device comprising:
communication circuitry,
memory storing instructions, and
a processor operably coupled to the communication circuitry, and the memory,
wherein the instructions, when executed by the processor, cause the electronic device to:
obtain, through the communication circuitry, first images from a first camera,
obtain, through the communication circuitry, second images from a second camera of which a shutter speed is slower than a shutter speed of the first camera,
identify a first image and a second image obtained at corresponding times from the first images and the second images,
set a first region of interest (ROI) of an object with a specified type in the first image,
set a second ROI at the same position as the first ROI in the second image, and
generate the first image with the first ROI set and the second image with the second ROI set as training data.

2. The electronic device of claim 1,
wherein the second camera is arranged to have an angle corresponding to an angle of the first camera,
wherein a lens property of the second camera is identical to a lens property of the first camera, and
wherein the instructions, when executed by the processor, cause the electronic device to:
instruct the first camera and the second camera to take pictures at corresponding times.

3. The electronic device of claim 1,
wherein the instructions, when executed by the processor, cause the electronic device to:
after instructing the first camera and the second camera to take pictures at corresponding times, obtain the first images and the second images for a specified time,
based on comparing a reference image among the first images and each of the second images, identify an image obtained at a corresponding time with the reference image, and
identify the second image from the second images, which has a frame difference equal to a frame difference from the first image to the reference image.

4. The electronic device of claim 1,
wherein the instructions, when executed by the processor, cause the electronic device to:
in the first image, generate a cropped first image by cropping a region of a specified size, and
based on the cropped first image, generate a cropped second image by cropping another region of a specified size in the second image.

5. The electronic device of claim 4,
wherein the instructions, when executed by the processor, cause the electronic device to:
identify normalized differences between a plurality of regions of the cropped first image and the second image,
identify normalized distances between feature points of the cropped first image and feature points of each of the plurality of regions of the second image, and
generate the cropped second image, by cropping a region where a weighted average between the normalized differences and the normalized distances is the lowest.

6. The electronic device of claim 4,
wherein the instructions, when executed by the processor, cause the electronic device to:
in the cropped first image, identify an object with a specified type,
set the first ROI within the object identified in the cropped first image,
set the position of the object in the cropped first image in the cropped second image, and
set the second ROI in the same position as the first ROI in the cropped first image in the cropped second image.

7. The electronic device of claim 6,
wherein the instructions, when executed by the processor, cause the electronic device to:
in the first ROI, based on a string identification algorithm, identify a string, and
label the identified string in the first ROI and the second ROI.

8. The electronic device of claim 7,
wherein the instructions, when executed by the processor, cause the electronic device to:
convert the first ROI into a specified shape based on a specified transformation algorithm, and
identify the string based on the string identification algorithm in the first ROI converted into the specified shape.

9. The electronic device of claim 1,
wherein the instructions, when executed by the processor, cause the electronic device to:
based on a difference between consecutive images among the first images, identify whether the electronic device is moved,
based on the electronic device not being moved, delete the first images and the second images, and
based on the electronic device being moved, generate the training data based on the first images and the second images.

10. A method executed by an electronic device including communication circuitry, comprising:
obtaining first images from a first camera through the communication circuitry,
obtaining, through the communication circuitry, second images from a second camera of which a shutter speed is slower than a shutter speed of the first camera,
identifying a first image and a second image obtained at a corresponding time from the first images and the second images,
setting a first region of interest (ROI) of an object with a specified type in the first image,
setting a second ROI at the same position as the first ROI in the second image, and
generating the first image with the first ROI set and the second image with the second ROI set as training data.

11. The method of claim 10, comprising:
after instructing the first camera and the second camera to take pictures at corresponding times, obtaining the first images and the second images for a specified time,
based on comparing a reference image among the first images and each of the second images, identifying an image obtained at a corresponding time with the reference image, and
identifying the second image from the second images, which has a frame difference equal to a frame difference from the first image to the reference image.

12. The method of claim 10, comprising:
in the first image, generating a cropped first image by cropping a region of a specified size, and
based on the cropped first image, generating a cropped second image by cropping another region of a specified size in the second image.

13. The method of claim 12, comprising:
identifying normalized differences between a plurality of regions of the cropped first image and the second image,
identifying normalized distances between feature points of the cropped first image and feature points of each of the plurality of regions of the second image,
generating the cropped second image, by cropping a region where a weighted average between the normalized differences and the normalized distances is the lowest.

14. The method of claim 12, comprising:
in the cropped first image, identifying an object with a specified type,
setting the first ROI within the object identified in the cropped first image,
setting the position of the object in the cropped first image in the cropped second image, and
setting the second ROI in the same position as the first ROI in the cropped first image in the cropped second image.

15. The method of claim 10, comprising:
based on a difference between consecutive images among the first images, identifying whether the electronic device is moved,
based on the electronic device not being moved, deleting the first images and the second images, and
based on the electronic device being moved, generating the training data based on the first images and the second images.

16. A non-transitory computer readable storage medium, storing one or more programs including instructions,
wherein the instructions, when executed by a processor of an electronic device including communication circuitry, cause the electronic device to:
obtain, through the communication circuitry, first images from a first camera,
obtain, through the communication circuitry, second images from a second camera of which a shutter speed is slower than a shutter speed of the first camera,
identify a first image and a second image obtained at a corresponding time from the first images and the second images,
set a first region of interest (ROI) of an object with a specified type in the first image,
set a second ROI at the same position as the first ROI in the second image, and
generate the first image with the first ROI set and the second image with the second ROI set as training data.

17. The non-transitory computer readable storage medium of claim 16,
wherein the instructions, when executed by the processor, cause the electronic device to:
in the first image, generate a cropped first image by cropping a region of a specified size, and
based on the cropped first image, generate a cropped second image by cropping another region of a specified size in the second image.

18. The non-transitory computer readable storage medium of claim 17,
wherein the instructions, when executed by the processor, cause the electronic device to:
identify normalized differences between a plurality of regions of the cropped first image and the second image,
identify normalized distances between feature points of the cropped first image and feature points of each of the plurality of regions of the second image, and
generate the cropped second image, by cropping a region where a weighted average between the normalized differences and the normalized distances is the lowest.

19. The non-transitory computer readable storage medium of claim 17,
wherein the instructions, when executed by the processor, cause the electronic device to:
in the cropped first image, identify an object with a specified type,
set the first ROI within the object identified in the cropped first image,
set the position of the object in the cropped first image in the cropped second image, and
set the second ROI in the same position as the first ROI in the cropped first image in the cropped second image.

20. The non-transitory computer readable storage medium of claim 16,
wherein the instructions, when executed by the processor, cause the electronic device to:
based on a difference between consecutive images among the first images, identify whether the electronic device is moved,
based on the electronic device not being moved, delete the first images and the second images, and
based on the electronic device being moved, generate the training data based on the first images and the second images.
